(19) United States
(12) Patent Application Publication
(10) Pub. No.: US 2008/0076566 A1
(43) Pub. Date: Mar. 27, 2008

(54) Storage medium having game program stored thereon and game apparatus

(75) Inventor: Takeshi Miyamoto, Kyoto-shi (JP)

Correspondence Address: NIXON & VANDERHYE, P.C., 901 NORTH GLEBE ROAD, 11TH FLOOR, ARLINGTON, VA, 22203, US

(73) Assignee: Nintendo Co., Ltd., Kyoto (JP)

(21) Appl. No.: 11/606,114

(22) Filed: Nov. 30, 2006

(30) Foreign Application Priority Data
Aug. 25, 2006 (JP) 2006-229325

(51) Int. Cl. A63F 13/00

(52) U.S. Cl. 463/37

(57) ABSTRACT

A moving start coordinate set associated with an object is calculated based on motion data output from a motion sensor for outputting the motion data in accordance with a motion of an input device, and a first difference coordinate set, as a difference between the moving start coordinate set and a reference trajectory, is calculated. A target coordinate set associated with the object is calculated, and a second difference coordinate set, as a difference between the target coordinate set and a reference trajectory, is calculated. A change difference coordinate set changing from the first difference coordinate set to the second difference coordinate set in accordance with time is calculated. The change difference coordinate set is added to the reference trajectory to calculate a correction coordinate set. The object is located at a position corresponding to the correction coordinate set in the virtual game space and displayed on the display device.

### CROSS REFERENCE TO RELATED APPLICATION

The disclosure of Japanese Patent Application No. 2006-229325, filed on Aug. 25, 2006 is incorporated herein by reference.

### BACKGROUND OF THE INVENTION

1. Field of the Invention

The present invention relates to a storage medium having a game program stored thereon and a game apparatus, and more specifically to a storage medium having a game program stored thereon for correcting an object which is drawn using an input device including an acceleration sensor, and a game apparatus for executing such a game program.

2. Description of the Background Art

For example, Japanese Laid-Open Patent Publication No. 2004-230070 (hereinafter, referred to as “patent document 1”) discloses a game apparatus for displaying an object with the drawing position thereof being corrected. When a predetermined operation is performed where a player object is located in a predetermined area, the game apparatus corrects the trajectory along which the player object is to move so that the trajectory becomes closer to a reference trajectory provided in advance. Specifically, the game apparatus sequentially adds a logical project, obtained by multiplying a difference between a coordinate set of the current position of the player object and a coordinate set on the reference trajectory by a predetermined coefficient, to the coordinate set of the current position of the player object, and thus corrects the position of the player object so that the position gradually becomes closer to the reference trajectory.

However, the game apparatus disclosed in patent document 1 does not allow the object to be operated at a high degree of freedom while the correction processing is executed. The reason is that the game apparatus corrects the drawing position of the object so that the position becomes closer to the predetermined reference trajectory. In addition, the above-described game apparatus corrects the coordinate set of a predetermined one point in the object. Therefore, the inclination of the object drawn after the correction is not associated with the correction of the coordinate set. As a result, the object may occasionally make an unnatural motion.

### SUMMARY OF THE INVENTION

Therefore, an object of the present invention is to provide a storage medium having stored thereon a game program for, when an input operation is performed using an input device including a motion sensor, correcting an object which is drawn using the input device at a high degree of freedom, and a game apparatus for executing such a game program.

The present invention has the following features to attain the object mentioned above. The reference numerals, step numbers and the like in parentheses in this section of the specification indicate the correspondence with the embodiments described later for easier understanding of the present invention, and do not limit the present invention in any way.

A first aspect of the present invention is directed to a storage medium having stored thereon a game program executable by a computer (30) of a game apparatus (5) for obtaining motion data from an input device (7) including a motion sensor (701) for outputting the motion data in accordance with a motion of the input device, moving an object (BO) located in a virtual game space and displaying the object on a display device (2). A reference trajectory (Dh) along which the object moves in the virtual game space is stored on a memory (33) (CPU 30 for executing step 91; hereinafter, only the step number of the corresponding processing will be described in this section of the specification). The game program causes the computer to execute a motion data obtaining step (S51), a start coordinate set calculation step (S52), a first difference calculation step (S93), a target coordinate set calculation step (S98), a second difference calculation step (S99), a change difference coordinate set calculation step (S102), a correction coordinate set calculation step (S104), and a display control step (S105). The motion data obtaining step obtains the motion data (Da) which is output from the motion sensor. The start coordinate set calculation step calculates a moving start coordinate set (PO) associated with the object in the virtual game space, based on the motion data obtained in the motion data obtaining step. The first difference calculation step calculates a first corresponding point on the reference trajectory corresponding to the moving start coordinate set from the reference trajectory stored on the memory, and calculates a first difference coordinate set (Dj), which is a difference between the first corresponding point and the moving start coordinate set. The target coordinate set calculation step calculates a target coordinate set (Dm) associated with the object in the virtual game space. The second difference calculation step calculates a second corresponding point on the reference trajectory corresponding to the target coordinate set from the reference trajectory stored on the memory, and calculates a second difference coordinate set (Do), which is a difference between the second corresponding point and the target coordinate set. The change difference coordinate set calculation step calculates a change difference coordinate set which changes from the first difference coordinate set to the second difference coordinate set in accordance with a time passage (number of frames) after a predetermined condition is fulfilled (Yes in S55). The correction coordinate set calculation step adds the change difference coordinate set calculated in accordance with the time passage to a coordinate set on the reference trajectory in accordance with the time passage to calculate a correction coordinate set (Dq). The display control step locates the object at a position corresponding to the correction coordinate set in the virtual game space and displays the object on the display device.

In a second aspect based on the first aspect, in the start coordinate set calculation step, the moving start coordinate set is calculated when the predetermined condition is fulfilled. In the first difference calculation step, the first difference coordinate set is calculated when the predetermined condition is fulfilled. In the target coordinate set calculation step, the target coordinate set is calculated when the predetermined condition is fulfilled. In the second difference calculation step, the second difference coordinate set is calculated when the predetermined condition is fulfilled.

In a third aspect based on the first aspect, in the change difference coordinate set calculation step, the change difference coordinate set is calculated so as to be changed from the first difference coordinate set to the second difference coordinate set by a constant ratio in accordance with the time passage.

In a fourth aspect based on the first aspect, the game program causes the computer to further execute a determination step (S55). The determination step determines that the predetermined condition is fulfilled when a value represented by the motion data obtained in the motion data obtaining step is equal to or greater than a predetermined value. In the change difference coordinate set calculation step, the change difference coordinate set is calculated in accordance with the time passage after it is determined that the predetermined condition is fulfilled in the determination step.

In a fifth aspect based on the first aspect, in the target coordinate set calculation step, the target coordinate set in the virtual game space is calculated based on a game parameter (T) which changes in accordance with predetermined game processing.

In a sixth aspect based on the first aspect, in the target coordinate set calculation step, the target coordinate set is calculated on a predetermined plane (M) which is set in the virtual game space. In the second difference calculation step, an intersection (Cp) of the predetermined plane and the reference trajectory is set as the second corresponding point on the reference trajectory corresponding to the target coordinate set.

In a seventh aspect based on the first aspect, the game program causes the computer to further execute an another object moving step (S95 through S97). The another object moving step moves another object (Ba) in the virtual game space. In the target coordinate set calculation step, a prospected intersection position (Cp), at which the predetermined plane set in the virtual game space and the another object cross each other, is prospected based on a prospected movement (T) of the another object, and the target coordinate set associated with the object contacting the another object at the prospected intersection position in the virtual game space is calculated.

In an eighth aspect based on the first aspect, the motion sensor is an acceleration sensor for detecting an acceleration in at least one axial direction applied to the input device. The motion data is acceleration data representing the acceleration detected by the acceleration sensor.

A ninth aspect of the present invention is directed to a storage medium having stored thereon a game program executable by a computer of a game apparatus for obtaining motion data from an input device including a motion sensor for outputting the motion data in accordance with a motion of the input device, moving an object located in a virtual game space and displaying the object on a display device. A reference inclination transition (Dh) which represents reference for an inclination change of the object in accordance with the movement thereof in the virtual game space is stored on a memory. The game apparatus causes the computer to execute a motion data obtaining step, a start inclination calculation step (S53), a first difference calculation step (S94), a target inclination calculation step (S98), a second difference calculation step (S100), a change difference inclination calculation step (S103), a correction inclination calculation step (S104), and a display control step. The motion data obtaining step obtains the motion data which is output from the motion sensor. The start inclination calculation step calculates an inclination of the object when the object starts moving in the virtual game space, based on the motion data obtained in the motion data obtaining step. The first difference calculation step calculates a reference inclination corresponding to the inclination calculated in the start inclination calculation step from the reference inclination transition stored on the memory, and calculates a first difference inclination (Dk), which is a difference between the reference inclination and the inclination calculated in the start inclination calculation step. The target inclination calculation step calculates a target inclination (Dn) of the object in the virtual game space. The second difference calculation step calculates a reference inclination corresponding to the target inclination from the reference inclination transition stored on the memory, and calculates a second difference inclination (Dp), which is a difference between the reference inclination and the target inclination. The change difference inclination calculation step calculates a change difference inclination which changes from the first difference inclination to the second difference inclination in accordance with a time passage after a predetermined condition is fulfilled. The correction inclination calculation step adds the change difference inclination calculated in accordance with the time passage to the reference inclination transition in accordance with the time passage to calculate a correction inclination (Dr). The display control step sets the inclination of the object in the virtual game space as the correction inclination and displays the object on the display device.

In a tenth aspect based on the ninth aspect, in the start inclination calculation step, the inclination of the object when the object starts moving is calculated when the predetermined condition is fulfilled. In the first difference calculation step, the first difference inclination is calculated when the predetermined condition is fulfilled. In the target inclination calculation step, the target inclination is calculated when the predetermined condition is fulfilled. In the second difference calculation step, the second difference inclination is calculated when the predetermined condition is fulfilled.

In an eleventh aspect based on the ninth aspect, in the change difference inclination calculation step, the change difference inclination is calculated so as to be changed from the first difference inclination to the second difference inclination by a constant ratio in accordance with the time passage.

In a twelfth aspect based on the ninth aspect, the game program causes the computer to further execute a determination step. The determination step determines that the predetermined condition is fulfilled when a value represented by the motion data obtained in the motion data obtaining step is equal to or greater than a predetermined value. In the change difference inclination calculation step, the change difference inclination is calculated in accordance with the time passage after it is determined that the predetermined condition is fulfilled in the determination step.

In a thirteenth aspect based on the ninth aspect, in the target inclination calculation step, the target inclination in the virtual game space is calculated based on a game parameter which changes in accordance with predetermined game processing.

In a fourteenth aspect based on the ninth aspect, in the target inclination calculation step, the target inclination is calculated for the object located on a predetermined plane which is set in the virtual game space. In the second difference calculation step, the inclination of the object located on the predetermined plane in the reference inclination transition is set as the reference inclination corresponding to the target inclination.

In a fifteenth aspect based on the ninth aspect, the game program causes the computer to further execute an another object moving step. The another object moving step moves another object in the virtual game space. In the target inclination calculation step, a prospected intersection position, at which the predetermined plane set in the virtual game space and the another object cross each other, is prospected based on a prospected movement of the another object, and the inclination of the object located at the prospected intersection position is calculated as the target inclination.

In a sixteenth aspect based on the ninth aspect, the motion sensor is an acceleration sensor for detecting an acceleration in at least one axial direction applied to the input device. The motion data is acceleration data representing the acceleration detected by the acceleration sensor.

A seventeenth aspect of the present invention is directed to a game apparatus for obtaining motion data from an input device including a motion sensor for outputting the motion data in accordance with a motion of the input device, moving an object located in a virtual game space and displaying the object on a display device. The game apparatus comprises a memory, motion data obtaining means, start coordinate set calculation means, first difference calculation means, target coordinate set calculation means, second difference calculation means, change difference coordinate set calculation means, correction coordinate set calculation means, and display control means. The memory stores a reference trajectory along which the object moves in the virtual game space. The motion data obtaining means obtains the motion data which is output from the motion sensor. The start coordinate set calculation means calculates a moving start coordinate set associated with the object in the virtual game space, based on the motion data obtained by the motion data obtaining means. The first difference calculation means calculates a first corresponding point on the reference trajectory corresponding to the moving start coordinate set from the reference trajectory stored on the memory, and calculates a first difference coordinate set, which is a difference between the first corresponding point and the moving start coordinate set. The target coordinate set calculation means calculates a target coordinate set associated with the object in the virtual game space. The second difference calculation means calculates a second corresponding point on the reference trajectory corresponding to the target coordinate set from the reference trajectory stored on the memory, and calculates a second difference coordinate set, which is a difference between the second corresponding point and the target coordinate set. The change difference coordinate set calculation means calculates a change difference coordinate set which changes from the first difference coordinate set to the second difference coordinate set in accordance with a time passage after a predetermined condition is fulfilled. The correction coordinate set calculation means adds the change difference coordinate set calculated in accordance with the time passage to a coordinate set on the reference trajectory in accordance with the time passage to calculate a correction coordinate set. The display control means locates the object at a position corresponding to the correction coordinate set in the virtual game space and displays the object on the display device.

An eighteenth aspect of the present invention is directed to a game apparatus for obtaining motion data from an input device including a motion sensor for outputting the motion data in accordance with a motion of the input device, moving an object located in a virtual game space and displaying the object on a display device. The game apparatus comprises a memory, motion data obtaining means, start inclination calculation means, first difference calculation means, target inclination calculation means, second difference calculation means, change difference inclination calculation means, correction inclination calculation step, and display control means. The memory stores a reference inclination transition which represents reference for an inclination change of the object in accordance with the movement thereof in the virtual game space. The motion data obtaining means obtains the motion data which is output from the motion sensor. The start inclination calculation means calculates an inclination of the object when the object starts moving in the virtual game space, based on the motion data obtained by the motion data obtaining means. The first difference calculation means calculates a reference inclination corresponding to the inclination calculated by the start inclination calculation means from the reference inclination transition stored on the memory, and calculates a first difference inclination, which is a difference between the reference inclination and the inclination calculated by the start inclination calculation means. The target inclination calculation means calculates a target inclination of the object in the virtual game space. The second difference calculation means calculates a reference inclination corresponding to the target inclination from the reference inclination transition stored on the memory, and calculates a second difference inclination, which is a difference between the reference inclination and the target inclination. The change difference inclination calculation means calculates a change difference inclination which changes from the first difference inclination to the second difference inclination in accordance with a time passage after a predetermined condition is fulfilled. The correction inclination calculation means adds the change difference inclination calculated in accordance with the time passage to the reference inclination transition in accordance with the time passage to calculate a correction inclination. The display control means sets the inclination of the object in the virtual game space as the correction inclination and displays the object on the display device.

According to the first aspect, a start coordinate set from which the object starts moving, a coordinate set of a point in the middle of the movement, and a termination coordinate set of the movement of the object can be freely set. Therefore, the moving trajectory of the object can be corrected at a high degree of freedom while being along the reference trajectory. The object drawn using the input device can be corrected at a high degree of freedom so as to appear to move naturally and thus realistically.

According to the second aspect, at the time when the predetermined condition is fulfilled, the target position to which the object is to move, and the difference between the target position and the point on the reference trajectory corresponding to the target position, are obtained. Thus, a correction amount for the target position with respect to the point on the reference trajectory corresponding to the target position is obtained. Namely, calculations are not performed in each frame in the game processing, but are performed only when the predetermined condition is fulfilled. Therefore, the processing load is alleviated.

According to the third aspect, the correction amount with respect to the reference trajectory changes by a constant ratio from the moving start position to the target position. Therefore, a smooth moving trajectory along the reference trajectory is obtained.

According to the fourth aspect, it is determined that the predetermined condition is fulfilled when the value of the motion data which is output from the input device is equal to or greater than a predetermined value. Therefore, the movement of the object in the virtual game space can be started in accordance with the operation of, for example, the player holding and swinging the input device.

According to the fifth aspect, the target coordinate set is calculated in accordance with a game parameter which changes in accordance with the game processing. Therefore, the target position is not fixed but is freely set. Even though the target position is changed, the moving trajectory of the object can be corrected at a high degree of freedom while following the reference trajectory.

According to the sixth aspect, the moving trajectory can be corrected based on the target position on a predetermined plane.

According to the seventh aspect, the moving trajectory of the object can be corrected along the reference trajectory, such that the object crosses another object moving in the virtual game space.

According to the eighth aspect, the motion of the input device can be calculated by performing a calculation on the value represented by the acceleration data which is output from the acceleration sensor built in the input device. Therefore, the acceleration data can be used as the motion data.

According to the ninth through sixteenth aspects, a correction on the inclination of the object in the virtual game space provides substantially the same effects as those of the correction on the position of the object.

A game apparatus according to the present invention provides substantially the same effects as those of the storage medium having the above-described game program stored thereon.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an external view of a game system 1 according to an embodiment of the present invention;

FIG. 2 is a functional block diagram of a game apparatus main body 5 shown in FIG. 1;

FIG. 3 is an isometric view of a controller 7 shown in FIG. 1 seen from the top rear side thereof;

FIG. 4 is an isometric view of the controller 7 shown in FIG. 3 seen from the bottom front side thereof;

FIG. 5 is an isometric view of the controller 7 in the state where an upper casing is removed;

FIG. 6 is an isometric view of the controller 7 shown in FIG. 3 in the state where a lower casing is removed;

FIG. 7 is a block diagram illustrating a structure of the controller 7 shown in FIG. 3;

FIG. 8 shows how the controller 7 is used to perform a game operation;

FIG. 9 shows the controller 7 in the state of standing still upright;

FIG. 10 shows an example of a baseball game drawn on a monitor 2 in accordance with X-, Y- and Z-axis direction acceleration data received from the controller 7;

FIG. 11 shows a virtual game space seen in a horizontal direction to illustrate a hold-up motion of a bat object BO;

FIG. 12 shows the virtual game space seen in a vertical direction from above to illustrate the hold-up motion of the bat object BO;

FIG. 13 shows a state where the bat object BO is swung in the virtual game space;

FIG. 14 shows main data stored on a main memory 33 in the game apparatus main body 5;

FIG. 15 is a flowchart illustrating a flow of game processing executed by the game apparatus main body 5;

FIG. 16 is a flowchart illustrating a subroutine of support position calculation processing instep 52 shown in FIG. 15 in detail;

FIG. 17 is a flowchart illustrating a subroutine of inclination calculation processing in step 53 shown in FIG. 15 in detail;

FIG. 18 is a flowchart illustrating a subroutine of swing processing in step 56 shown in FIG. 15 in detail;

FIG. 19 is a flowchart illustrating a subroutine of first swing initial processing in step 81 shown in FIG. 18 in detail;

FIG. 20 is a flowchart illustrating a subroutine of correction and drawing processing in steps 82 and 86 shown in FIG. 18 in detail;

FIG. 21 is a flowchart illustrating a subroutine of second swing initial processing in step 85 shown in FIG. 18 in detail;

FIG. 22 shows an exemplary state of the controller 7 inclined from the upright state;

FIG. 23 shows an exemplary state of the bat object BO shifted in position and inclination during the hold-up motion;

FIG. 24A shows an exemplary state of bat object BOi at the swing start point seen in the horizontal direction of the virtual game space;

FIG. 24B shows the exemplary state of bat object BOi at the swing start point seen in the vertical direction from above of the virtual game space;

FIG. 25 shows an exemplary setting of support position POe and the inclination of bat object BOe corresponding to the ball reach point Cp;

FIG. 26A shows an exemplary state of bat object BOe corresponding to the ball reach point Cp seen in the horizontal direction of the virtual game space;

FIG. 26B shows the exemplary state of bat object BOe corresponding to the ball reach point Cp seen in the vertical direction from above of the virtual game space; and

FIG. 27 shows an exemplary swing of the bat object BO displayed by the swing processing in FIG. 18.

### DESCRIPTION OF THE PREFERRED EMBODIMENTS

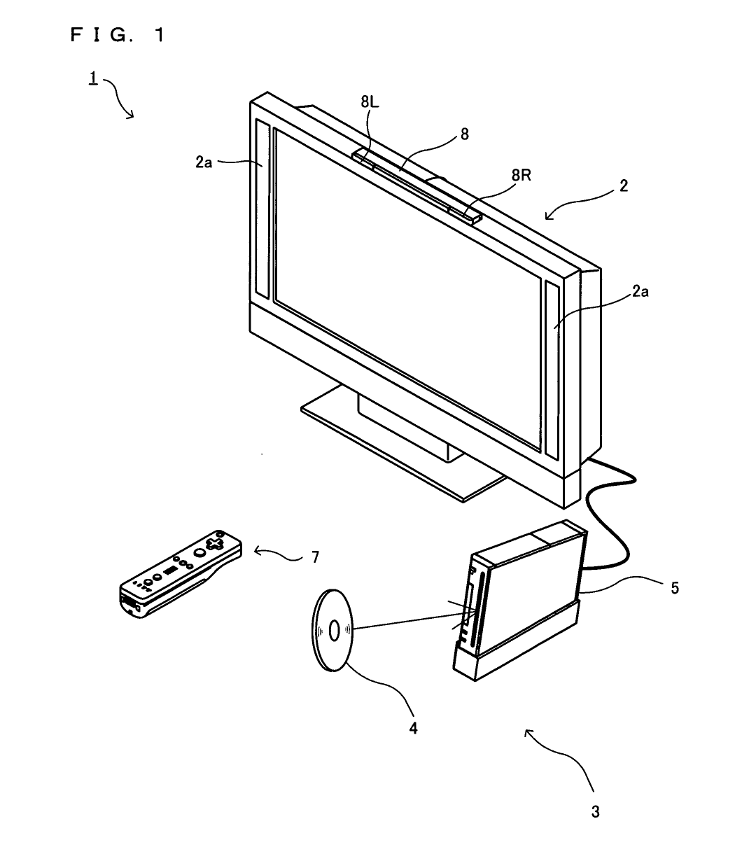

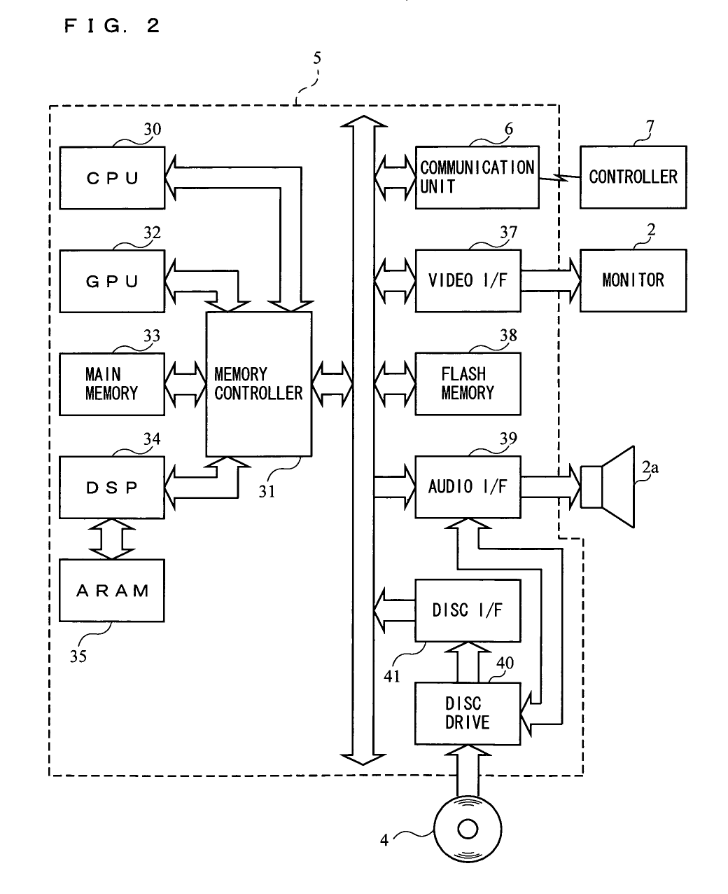

With reference to FIG. 1, a game apparatus according to one embodiment of the present invention will be described. Hereinafter, in order to give a specific description, a game system 1 including an installation type game apparatus 3, which is an exemplary game apparatus according to the present invention, will be described. FIG. 1 is an external view of the game system 1 including the installation type game apparatus 3. FIG. 2 is a block diagram of a game apparatus main body 5. Hereinafter, the game system 1 will be described.

As shown in FIG. 1, the game system 1 includes a home-use TV receiver (hereinafter, referred to as a “monitor”) 2 as an example of display means and the installation type game apparatus 3 connected to the monitor 2 via a connection cord. The monitor 2 includes speakers 2a for outputting an audio signal which is output from the game apparatus main body 5. The game apparatus 3 includes an optical disc 4 having stored thereon a game program as an exemplary information processing program according to the present invention, the game apparatus main body 5 including a computer for executing the game program stored on the optical disc 4 and causing the monitor 2 to display a game image, and a controller 7 for providing the game apparatus main body 5 with operation information required to play a game, for example, images of characters and the like displayed in the game image.

The game apparatus main body 5 has a built-in communication unit 6 (FIG. 2). The communication unit 6 receives data which is wirelessly transmitted from the controller 7, and transmits data from the game apparatus main body 5 to the controller 7. The controller 7 and the game apparatus main body 5 communicate each other wirelessly. On the game apparatus main body 5, the optical disc 4 as an exemplary exchangeable information storage medium is detachably mounted. The game apparatus main body 5 has, on a front main surface thereof, a power ON/OFF switch, a game processing reset switch, an opening for mounting the optical disc 4, an eject switch for removing the optical disc 4 from the opening, and the like.

On the game apparatus main body 5, a flash memory 38 (FIG. 2) is mounted, which acts as a backup memory for fixedly storing saved data or the like. The game apparatus main body 5 executes a game program or the like stored on the optical disc 4 and displays the result on the monitor 2 as a game image. The game apparatus main body 5 can also reproduce a state of a game played in the past using saved data stored on the flash memory 38 and display the game image on the monitor 2. A player playing with the game apparatus main body 5 can enjoy the game by operating the controller 7 while watching the game image displayed on the monitor 2.

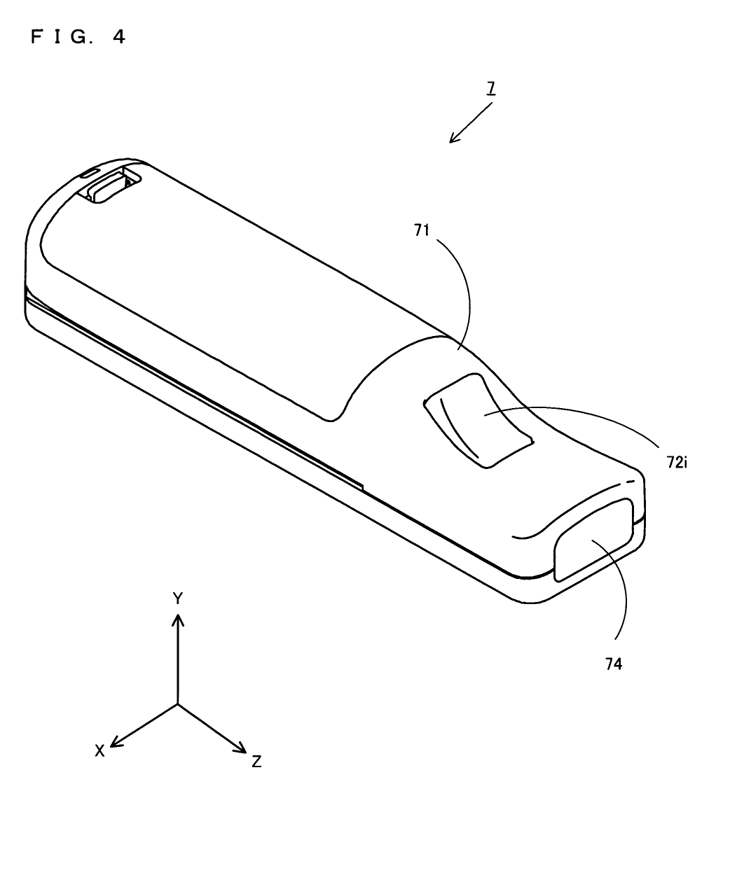

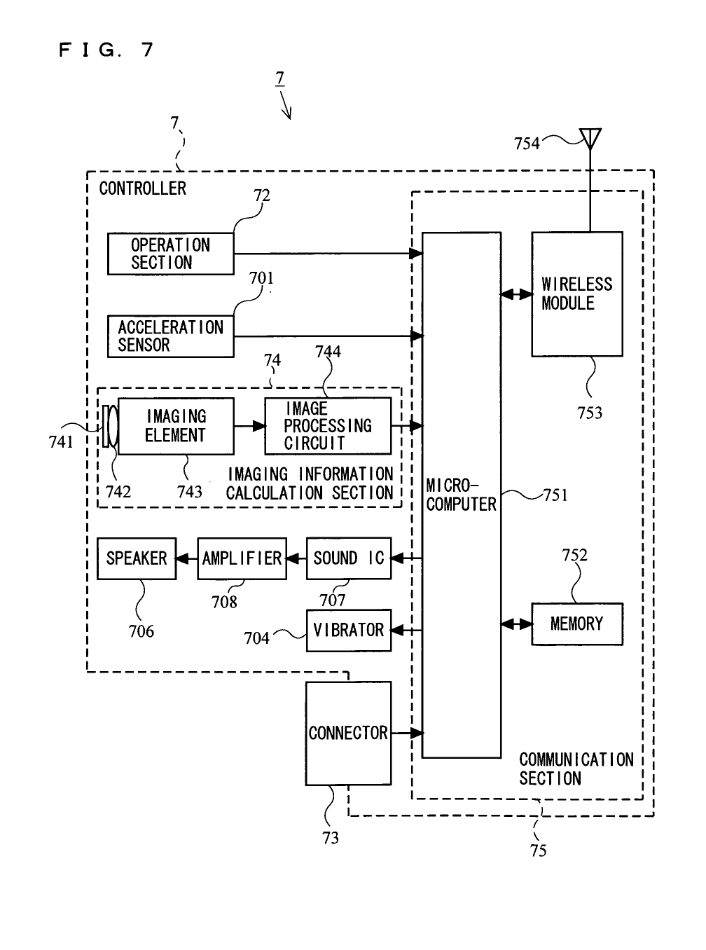

The controller 7 wirelessly transmits transmission data such as operation information or the like to the game apparatus main body 5 having the built-in communication unit 6, using the technology of Bluetooth (registered trademark) or the like. The controller 7 is operation means for mainly operating a player object or the like appearing in a game space displayed on a display screen of the monitor 2. The controller 7 includes a housing which is small enough to be held by one hand and a plurality of operation buttons (including a cross key, a stick and the like) exposed on a surface of the housing. As described later in detail, the controller 7 also includes an imaging information calculation section 74 (FIG. 4) for taking an image viewed from the controller 7. As an example of an imaging subject of the imaging information calculation section 74, two LED modules (hereinafter, referred to as “markers”) 8L and 8R are provided in the vicinity of the display screen of the monitor 2. The markers 8L and 8R each output infrared light forward from the monitor 2. The controller 7 can generate a sound or vibration in accordance with the transmission data which is wirelessly transmitted from the communication unit 6 of the game apparatus main body 5 and received by a communication section 75 (FIG. 7) in the controller 7.

As shown in FIG. 2, the game apparatus main body 5 includes, for example, a CPU (central processing unit) 30 for executing various types of programs. The CPU 30 executes a start program stored on a boot ROM (not shown) to, for example, initialize memories including a main memory 33, and then executes a game program stored on the optical disc 4 to perform game processing or the like in accordance with the game program. The CPU 30 is connected to a GPU (Graphics Processing Unit) 32, the main memory 33, a DSP (Digital Signal Processor) 34, an ARAM (Audio RAM) 35 and the like via a memory controller 31. The memory controller 31 is connected to the communication unit 6, a video I/F (interface) 37, the flash memory 38, an audio I/F 39, and a disc I/F 41 via a predetermined bus. The video I/F 37, the audio I/F 39 and the disc I/F 41 are respectively connected to the monitor 2, the speaker 2a and a disc drive 40.

The GPU 32 performs image processing based on an instruction from the CPU 30. The GPU 32 includes, for example, a semiconductor chip for performing calculation processing necessary for displaying 3D graphics. The GPU 32 performs the image processing using a memory dedicated for image processing (not shown) or a part of the storage area of the main memory 33. The GPU 32 generates game image data and a movie to be displayed on the monitor 2 using such memories, and outputs the generated data or movie to the monitor 2 via the memory controller 31 and the video I/F 37 as necessary.

The main memory 33 is a storage area used by the CPU 30, and stores a game program or the like necessary for processing performed by the CPU 30 as necessary. For example, the main memory 33 stores a game program, various types of data or the like read from the optical disc 4 by the CPU 30. The game program, the various types of data or the like stored on the main memory 33 are executed by the CPU 30.

The DSP 34 processes sound data or the like generated by the CPU 30 during the execution of the game program. The DSP 34 is connected to the ARAM 35 for storing the sound data or the like. The ARAM 35 is used when the DSP 34 performs predetermined processing (e.g., storage of the game program or sound data already read). The DSP 34 reads the sound data stored on the ARAM 35 and outputs the sound data to the speaker 2a included in the monitor 2 via the memory controller 31 and the audio I/F 39.

The memory controller 31 comprehensively controls data transfer, and is connected to the various I/Fs described above. As described above, the communication unit 6 receives transmission data from the controller 7 and outputs the transmission data to the CPU 30. The communication unit 6 also transmits transmission data which is output from the CPU 30 to the communication section 75 of the controller 7. The video I/F 37 is connected to the monitor 2. The audio I/F 39 is connected to the speaker 2a built in the monitor 2, such that the sound data read by the DSP 34 from the ARAM 35 or sound data directly output from the disc drive 40 is output through the speaker 2a. The disc I/F 41 is connected to the disc drive 40. The disc drive 40 reads data stored at a predetermined reading position of the optical disc 4 and outputs the data to a bus of the game apparatus main body 5 or the audio I/F 39.

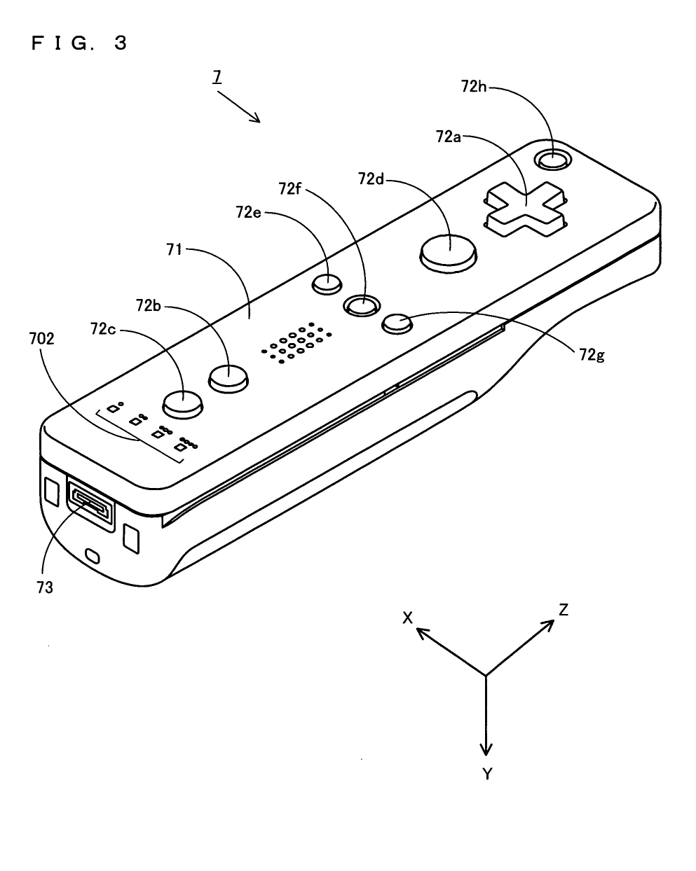

With reference to FIG. 3 and FIG. 4, the controller 7 will be described. FIG. 3 is an isometric view of the controller 7 seen from the top rear side thereof. FIG. 4 is an isometric view of the controller 7 seen from the bottom front side thereof.

As shown in FIG. 3 and FIG. 4, the controller 7 includes a housing 71 formed by plastic molding or the like. The housing 71 has a plurality of operation sections 72. The housing 71 has a generally parallelepiped shape extending in a longitudinal direction from front to rear. The overall size of the housing 71 is small enough to be held by one hand of an adult or even a child.

At the center of a front part of a top surface of the housing 71, a cross key 72a is provided. The cross key 72a is a cross-shaped four-direction push switch. The cross key 72a includes projecting operation portions corresponding to the four directions (front, rear, right and left) and arranged at an interval of 90 degrees. The player selects one of the front, rear, right and left directions by pressing one of the operation portions of the cross key 72a. Through an operation on the cross key 72a, the player can, for example, instruct a direction in which a player character or the like appearing in a virtual game world is to move or select one of a plurality of alternatives.

The cross key 72a is an operation section for outputting an operation signal in accordance with the above-described direction input operation performed by the player, but such an operation section may be provided in another form. For example, the operation section may include four push switches provided in a cross arrangement, and output an operation signal in accordance with the push switch which has been pressed. The operation section may further include a center switch provided at the intersection of the cross in addition to the four push switches. Alternatively, the cross key 72a may be replaced with an operation section which includes an inclinable stick (so-called joystick) projecting from the top surface of the housing 71 and outputs an operation signal in accordance with the inclining direction of the stick. Still alternatively, the cross key 72a may be replaced with an operation section which includes a disc-shaped member horizontally slidable and outputs an operation signal in accordance with the sliding direction of the disc-shaped member. Still alternatively, the cross key 72a may be replaced with a touch pad.

Rearward to the cross key 72a on the top surface of the housing 71, a plurality of operation buttons 72b through 72g are provided. The operation buttons 72b through 72g are each an operation section for outputting a respective operation signal when the player presses ahead thereof. For example, the operation buttons 72b through 72d are assigned functions of a first button, a second button, and an A button. The operation buttons 72e through 72g are assigned functions of a minus button, a home button and a plus button, for example. The operation buttons 72b through 72g are assigned various functions in accordance with the game program executed by the game apparatus main body 5. In the exemplary arrangement shown in FIG. 3, the operation buttons 72b through 72d are arranged in a line extending in the front-rear direction at the center of the top surface of the housing 71. The operation buttons 72e through 72g are arranged in a line extending in the left-right direction between the operation buttons 72b and 72d. The operation button 72f has a top surface thereof buried in the top surface of the housing 71, so as not to be inadvertently pressed by the player.

Forward to the cross key 72a on the top surface of the housing 71, an operation button 72h is provided. The operation button 72h is a power switch for remote-controlling the power of the game apparatus main body 5 to be on or off. The operation button 72h also has a top surface thereof buried in the top surface of the housing 71, so as not to be inadvertently pressed by the player.

Rearward to the operation button 72c on the top surface of the housing 71, a plurality of LEDs 702 are provided. The controller 7 is assigned a controller type (number) so as to be distinguishable from the other controllers 7. For example, the LEDs 702 are used for informing the player of the controller type which is currently set to the controller 7 that he/she is using. Specifically, when the controller 7 transmits the transmission data to the communication unit 6, one of the plurality of LEDs corresponding to the controller type is lit up.

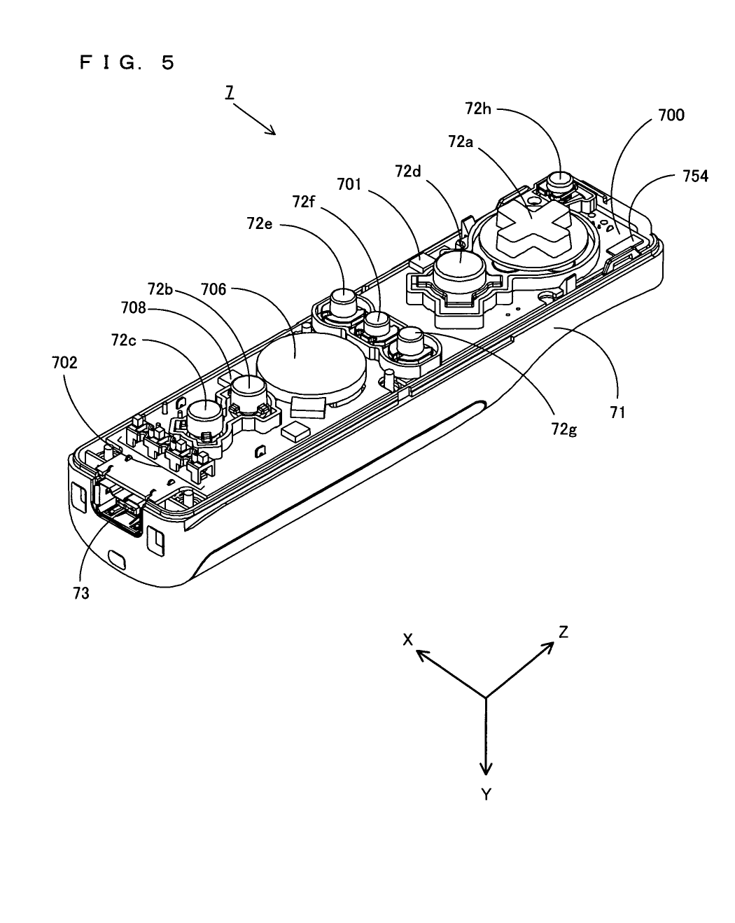

On the top surface of the housing 71, sound holes for outputting a sound from a speaker (speaker 706 in FIG. 5) described later is provided between the operation button 72b and the operation buttons 72e through 72g.

On a bottom surface of the housing 71, a recessed portion is formed. The recessed portion is formed at a position at which an index finger or middle finger of the player is located when the player holds the controller 7 with one hand in the state where a front surface of the controller 7 is directed toward the markers 8L and 8R. On a slope surface of the recessed portion, an operation button 72i is provided. The operation button 72i is an operation section acting as, for example, a B button.

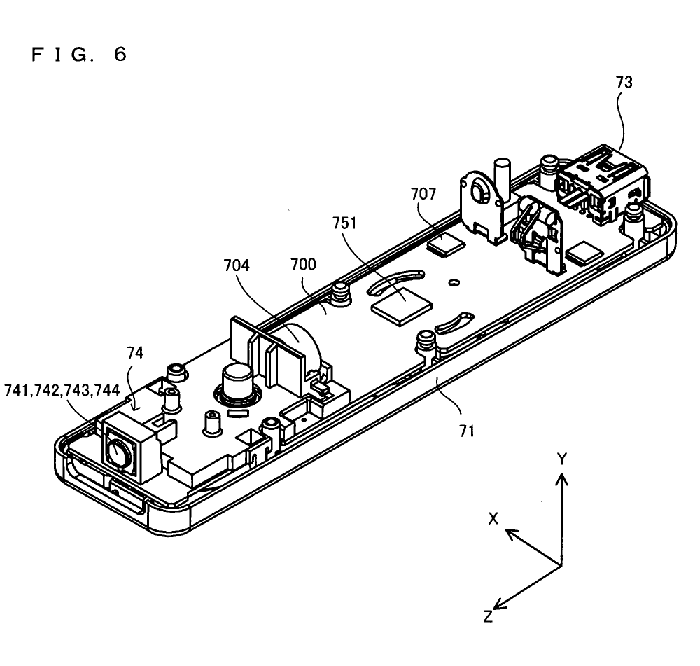

On the front surface of the housing 71, an imaging element 743 (see FIG. 6) included in the imaging information calculation section 74 is provided. The imaging information calculation section 74 is a system for analyzing image data taken by the controller 7 and detecting the position of the center of gravity, the size and the like of an area having a high brightness in the image data. The imaging information calculation section 74 has, for example, a maximum sampling period of about 200 frames/sec., and therefore can trace and analyze even a relatively fast motion of the controller 7. The structure of the imaging information calculation section 74 will be described later in detail. On a rear surface of the housing 71, a connector 73 is provided. The connector 73 is, for example, a edge connector, and is used for engaging and connecting the controller 7 with a connection cable.

In order to give a specific description below, a coordinate system which is set for the controller 7 will be defined. As shown in FIG. 3 and FIG. 4, X, Y and Z axes perpendicular to one another are defined for the controller 7. Specifically, the longitudinal direction of the housing 71, i.e., the front-rear direction of the controller 7, is set as the Z axis. A direction toward the front surface of the controller 7 (the surface having the imaging information calculation section 74) is set as a positive Z-axis direction. The up-to-down direction of the controller 7 is set as the Y axis. A direction toward the top surface of the controller housing 71 (the surface having the operation button 72i) is set as a positive Y-axis direction. The left-right direction of the controller 7 is set as the X axis. A direction toward a left surface of the housing 71 (the surface which is not shown in FIG. 3 but is shown in FIG. 4) is set as a positive X-axis direction.

With reference to FIG. 5 and FIG. 6, an internal structure of the controller 7 will be described. FIG. 5 is an isometric view of the controller 7 seen from the rear side, illustrating a state where an upper casing (a part of the housing 71) of the controller 7 is removed. FIG. 6 is an isometric view of the controller 7 seen from the front side, illustrating a state where a lower casing (a part of the housing 71) of the controller 7 is removed. FIG. 6 shows a reverse side of a substrate 700 shown in FIG. 5.

As shown in FIG. 5, the substrate 700 is fixed inside the housing 71. On a top main surface of the substrate 700, the operation buttons 72a through 72h, an acceleration sensor 701, the LEDs 702, an antenna 754 and the like are provided. These elements are connected to a microcomputer 751 (see FIG. 6 and FIG. 7) or the like via lines (not shown) formed on the substrate 700 or the like. The controller 7 acts as a wireless controller owing to a wireless module 753 (see FIG. 7) and the antenna 754. The housing 71 accommodates a quartz vibrator for generating a reference clock of the microcomputer 751 described later in detail. On the top main surface of the substrate 700, the speaker 706 and an amplifier 708 are provided. The acceleration sensor 701 is provided on the substrate 700 to the left of the operation button 72d (i.e., in a peripheral area of the substrate 700, not in a central area). Owing to such an arrangement, as the controller 7 rotates around the longitudinal direction thereof, the acceleration sensor 701 detects an acceleration including a centrifugal force component in addition to a component of direction change of gravitational acceleration). As a result, the game apparatus main body 5 or the like can determine the rotation of the controller 7 at a high sensitivity based on the detected acceleration obtained by a predetermined calculation.

As shown in FIG. 6, at a front edge of a bottom main surface of the substrate 700, the image information calculation section 74 is provided. The image in formation calculation section 74 includes an infrared filter 741, a lens 742, the imaging element 743 and an image processing circuit 744 located in this order from the front surface of the controller 7. These elements are attached to the bottom main surface of the substrate 700. At a rear edge of the bottom main surface of the substrate 700, the connector 73 is attached. On the bottom main surface of the substrate 700, a sound IC 707 and the microcomputer 751 are provided. The sound IC 707 is connected to the microcomputer 751 and the amplifier 708 via lines provided on the substrate 700 or the like, and outputs a sound signal to the speaker 706 via the amplifier 708 in accordance with the sound data transmitted from the game apparatus main body 5.

On the bottom main surface of the substrate 700, a vibrator 704 is attached. The vibrator 704 is, for example, a vibration motor or a solenoid. The vibrator 704 is connected to the microcomputer 751 via lines provided on the substrate 700 or the like, and turns the microcomputer 751 on or off in accordance with vibration data transmitted from the game apparatus main body 5. The controller 7 is vibrated by an actuation of the vibrator 704, and the vibration is conveyed to the player holding the controller 7. Thus, a so-called vibration-responsive game is realized. Since the vibrator 704 is provided slightly forward with respect to the center of the housing 71, the housing 71 held by the player is largely vibrated. Thus, the player easily senses the vibration.

With respect to FIG. 7, the internal structure of the controller 7 will be described. FIG. 7 is a block diagram showing the structure of the controller 7.

As shown in FIG. 7, the controller 7 includes a communication section 75 therein in addition to the operation sections 72, the imaging information calculation section 74, the acceleration sensor 701, the vibrator 704, the speaker 706, the sound IC 707 and the amplifier 708 described above.

The imaging information calculation section 74 includes the infrared filter 741, the lens 742, the imaging element 743 and the image processing circuit 744. The infrared filter 741 allows only infrared light to pass therethrough, among light incident on the front surface of the controller 7. The lens 742 collects the infrared light which has passed through the infrared filter 741 and outputs the infrared light to the imaging element 743. The imaging element 743 is a solid-state imaging device such as, for example, a CMOS sensor or a CCD. The imaging element 743 takes an image of the infrared light collected by the lens 742. Accordingly, the imaging element 743 takes an image of only the infrared light which has passed through the infrared filter 741 for generating image data. The image data generated by the imaging element 743 is processed by the image processing circuit 744. Specifically, the image processing circuit 744 processes the image data obtained from the imaging element 743, detects an area thereof having a high brightness, and outputs the processing result data representing the coordinate set of the detected position and size of the area to the communication section 75. The imaging information calculation section 74 is fixed to the housing 71 of the controller 7. The imaging direction of the imaging information calculation section 74 can be changed by changing the direction of the housing 71.

The acceleration sensor 701 included in the controller 7 is preferably a three-axial acceleration sensor. The three-axial acceleration sensor 701 detects a linear acceleration in each of three directions, i.e., an up-down direction (Y-axis direction shown in FIG. 3), a left-right direction (X-axis direction shown in FIG. 3), and a front-rear direction (Z-axis direction shown in FIG. 3). In another embodiment, two-axial acceleration detection means for detecting a linear acceleration in each of only X-axis and Y-axis directions (or directions along another pair of axes) may be used depending on the type of control signals used for game processing. In still another embodiment, one-axial acceleration detection means for detecting a linear acceleration in only one of X-, Y-, and Z-axis directions may be used depending on the type of control signals used for game processing. For example, such a three-axial, two-axial, or one-axial acceleration sensor 701 may be available from Analog Devices, Inc. or STMicroelectronics N.V. The acceleration sensor 701 is preferably of a static capacitance coupling system based on the technology of MEMS (Micro Electro Mechanical Systems) provided by silicon precision processing. Alternatively, the three-axial, two-axial, or one-axial acceleration sensor 701 may be based on an existing acceleration detection technology (e.g., piezoelectric system or piezoelectric resistance system) or any other appropriate technology developed in the future.

The acceleration detection means used for the acceleration sensor 701 can detect only an acceleration along a straight line corresponding to each of the axes of the acceleration sensor 701 (linear acceleration). Namely, a direct output from the acceleration sensor 701 is a signal indicating the linear acceleration (static or dynamic) along each of one, two or three axes thereof. Hence, the acceleration sensor 701 cannot directly detect a physical property such as, for example, a motion along a nonlinear path (e.g., an arc path), rotation, revolution, angular displacement, inclination, position or posture.

Nonetheless, those skilled in the art would easily understand from the description of this specification that further information on the controller 7 can be estimated or calculated (determined) by executing additional processing on an acceleration signal which is output from the acceleration sensor 701. For example, when a static acceleration (gravitational acceleration) is detected, an inclination of the object (controller 7) with respect to the gravitational vector can be determined by performing calculations based on the inclination angle and the detected acceleration, using the output from the acceleration sensor 701. By combining the acceleration sensor 701 with the microcomputer 751 (or another processor included in the game apparatus main body 5 such as the CPU 30) in this manner, the inclination, posture or position of the controller 7 can be determined. Similarly, when the controller 7 including the acceleration sensor 701 is dynamically accelerated by a hand of the player, various motions and/or positions of the controller 7 can be calculated by processing an acceleration signal generated by the acceleration sensor 701. In another embodiment, the acceleration sensor 701 may include a built-in signal processing device, or another type of dedicated processing device, for executing desired processing on an acceleration signal which is output from the built-in acceleration detection means, before the signal is output to the microcomputer 751. For example, when the acceleration sensor 701 is for detecting a static acceleration (e.g., a gravitational acceleration), the built-in or dedicated processing device may convert the detected acceleration signal to a corresponding inclination angle (or another preferable parameter). The parameter indicating the acceleration detected by the acceleration sensor 701 is output to the communication section 75.

In another embodiment, a gyrosensor having a built-in rotation element or vibration element maybe used as a motion sensor for detecting a motion of the controller 7. One exemplary MEMS gyrosensor usable in this embodiment is available from Analog Devices, Inc. Unlike the acceleration sensor 701, a gyrosensor can directly sense a rotation (or an angular rate) around an axis of at least one gyro element built therein. Since a gyrosensor and an acceleration sensor are fundamentally different from each other, either sensor may be selected in accordance with the use. An output signal from the selected sensor needs to be processed in a manner appropriate to the selected sensor.

Specifically, when a gyrosensor is used for calculating an inclination or a posture, instead of an acceleration sensor, significant changes are made. More specifically, when a gyrosensor is used, an inclination value is initialized before the detection is started. The angular rate data which is output from the gyrosensor is integrated. Next, an inclination change amount is calculated from the initialized inclination value. In this case, the calculated inclination corresponds to the angle. By contrast, when an acceleration sensor is used, the inclination is calculated by comparing the value of a gravitational acceleration component of each axis with a predetermined reference value. Therefore, the calculated inclination can be represented with a vector. Even without initialization, an absolute direction detected by the acceleration detection means can be obtained. As for the nature of the value calculated as an inclination, the value calculated using a gyrosensor is an angle whereas the value calculated using an acceleration sensor is a vector. Therefore, when a gyrosensor is used instead of an acceleration sensor, the inclination data needs to be converted as predetermined in consideration of the differences between the two devices. The characteristics of a gyrosensor are known to those skilled in the art as well as the basic differences between two devices, and will not be further described in this specification. A gyrosensor is advantageous in directly sensing a rotation, whereas an acceleration sensor is advantageous in generally having a higher cost efficiency when applied to a controller as used in this embodiment.

The communication section 75 includes the microcomputer 751, a memory 752, the wireless module 753, and the antenna 754. The microcomputer 751 controls the wireless module 753 for wirelessly transmitting the transmission data, while using the memory 752 as a storage area during processing. The microcomputer 751 also controls the operation of the sound IC 707 and the vibrator 704 in accordance with the data transmitted from the game apparatus main body 5 to the wireless module 753 via the antenna 754. The sound IC 707 processes sound data or the like transmitted from the game apparatus main body 5 via the communication section 75. The microcomputer 751 actuates the vibrator 704 in accordance with, for example, the vibration data (e.g., a signal for turning the vibrator 704 on or off) transmitted from the game apparatus main body 5 via the communication section 75.

Data from the controller 7 including an operation signal (key data) from the operation section 72, acceleration signals in the three axial directions (X-axis, Y-axis and Z-axis direction acceleration data) from the acceleration sensor 701, and the processing result data from the imaging information calculation section 74 are output to the microcomputer 751. The microcomputer 751 temporarily stores the input data (key data, X-axis, Y-axis and Z-axis direction acceleration data, and the processing result data) in the memory 752 as transmission data which is to be transmitted to the communication unit 6. The wireless transmission from the communication section 75 to the communication unit 6 is performed at a predetermined time interval. Since game processing is generally performed at a cycle of 1/60 sec., the wireless transmission needs to be performed at a cycle of a shorter time period. Specifically, the game processing unit is 16.7 ms ( 1/60 sec.), and the transmission interval of the communication section 75 structured using the Bluetooth (registered trademark) technology is 5 ms. At the transmission timing to the communication unit 6, the microcomputer 751 outputs the transmission data stored in the memory 752 as a series of operation information to the wireless module 753. The wireless module 753 uses, for example, the Bluetooth (registered trademark) technology to radiate the operation information from the antenna 754 using a carrier wave of a predetermined frequency. Thus, the key data from the operation section 72, the X-axis, Y-axis and Z-axis direction acceleration data from the acceleration sensor 701, and the processing result data from the imaging information calculation section 74 are transmitted from the controller 7. The communication unit 6 of the game apparatus main body 5 receives the carrier wave signal, and the game apparatus main body 5 demodulates or decodes the carrier wave signal to obtain the series of operation information (the key data, the X-axis, Y-axis and Z-axis direction acceleration data, and the processing result data) Based on the obtained operation information and the game program, the CPU 30 of the game apparatus main body 5 performs the game processing. In the case where the communication section 75 is structured using the Bluetooth (registered trademark) technology, the communication section 75 can have a function of receiving transmission data which is wirelessly transmitted from other devices.

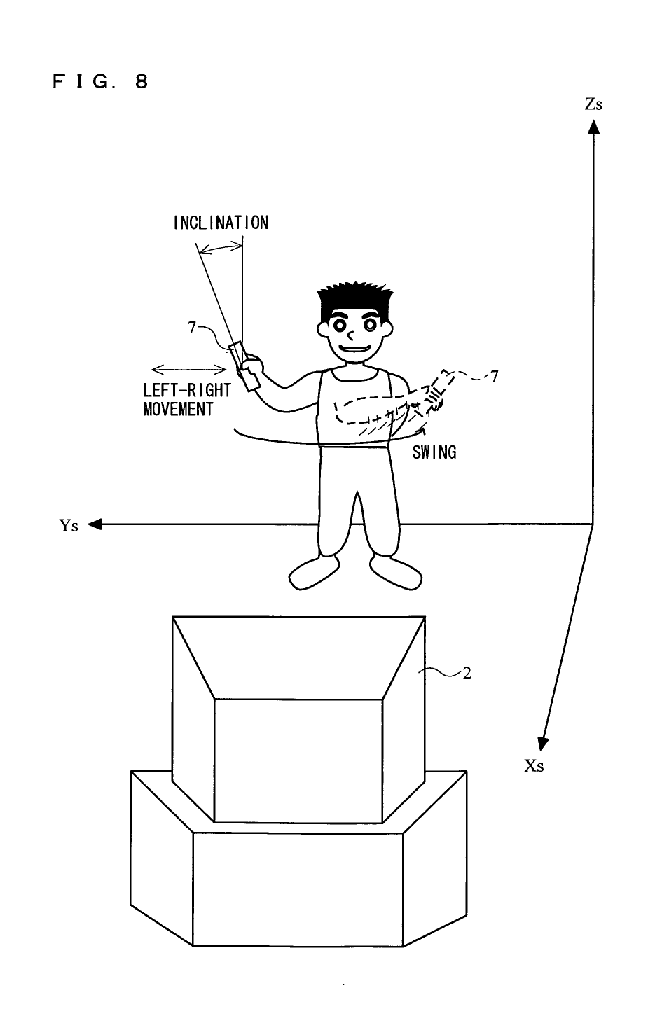

Before describing specific processing performed by the game apparatus main body 5, an overview of a game playable by the game apparatus main body 5 will be described. As shown in FIG. 8, the entire controller 7 is small enough to be held by one hand of an adult or even a child. In order to play a game with the game system 1 using the controller 7, the player holds the controller 7 with one hand or both hands as if holding a baseball bat such that the controller 7 stands upright (i.e., the front surface of the controller 7 is directed upward) with the top surface thereof directed toward the player.

In order to provide a specific description, Xs, Ys and Zs axes perpendicular to one another are defined as follows for a space in which the monitor 2 is installed and the player holding the controller 7 is existent. Specifically, the Xs axis runs in a horizontal direction connecting the player and the monitor 2, and a direction from the player toward the monitor 2 is a positive Xs-axis direction. The Ys axis runs in a horizontal direction perpendicular to the Xs axis, and a rightward direction for the player facing the display screen of the monitor 2 is a positive Ys-axis direction (in FIG. 8 showing the rear surface of the monitor 2, the leftward direction is the positive Ys axis direction). The Zs axis runs in the vertical direction in the space, and an upward direction is a positive Zs-axis direction.

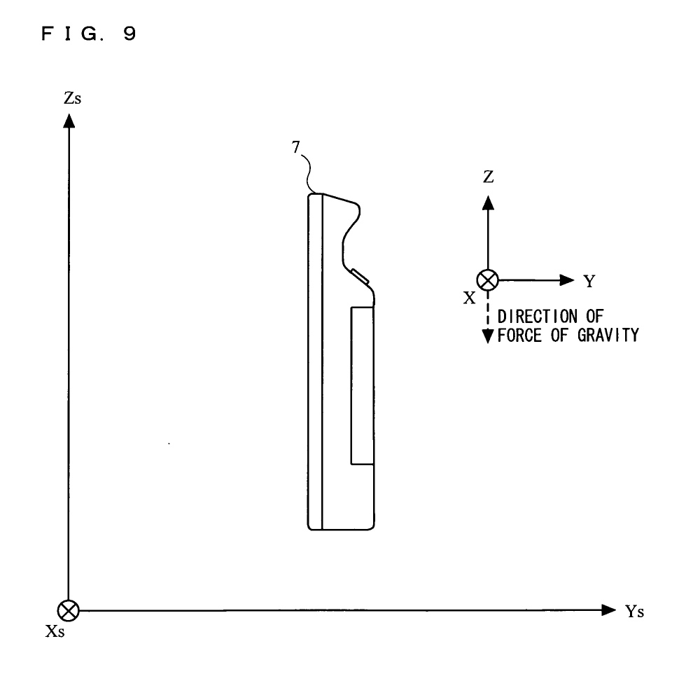

The player gives operation information (specifically, X-, Y-and Z-axis direction acceleration data) from the controller 7 to the game apparatus main body 5 by moving the controller 7 up, down, right or left or inclining the controller 7 from the upright state in accordance with the image displayed on the monitor 2. The player also gives the operation information from the controller 7 to the game apparatus main body 5 by swinging the controller 7 right and left. For example, as shown in FIG. 9, in the state where the controller 7 stands still upright with the top surface thereof being directed in the negative Ys-axis direction and the front surface thereof being directed in the positive Zs-axis direction, an acceleration in the negative Z-axis direction is applied to the controller 7 by a gravitational acceleration in the negative Zs-axis direction. FIG. 9 shows the controller 7 seen in the direction toward the monitor 2 (i.e., in the positive Xs-axis direction), and thus the directions are shown to be opposite from those in FIG. 8. When the player moves the controller 7 in the positive Ys-axis direction, an acceleration in the positive Y-axis direction is also applied to the controller 7. When the player inclines the controller 7 in the positive Ys-axis direction from the upright state, the direction of the gravitational acceleration applied to the controller 7 changes from the negative Z-axis direction to the positive Y-axis direction in accordance with the inclination angle. When the player swings the controller 7 right and left, an acceleration in the positive Z-axis direction is applied to the controller 7 in accordance with the centrifugal force of the swing. Such a change in the direction of acceleration applied to the controller 7 can be detected by the acceleration sensor 701. Therefore, the inclination or the motion of the controller 7 can be calculated by executing additional processing on the X-, Y- and Z-axis direction acceleration data which is output from the acceleration sensor 701. In general, when an acceleration generated in accordance with a motion is detected, an acceleration vector (or data on whether the acceleration is positive or negative) which is output from the acceleration sensor 701 is opposite to the acceleration direction applied to the controller 7. Needless to say, the inclination or the motion of the controller 7 needs to be calculated in consideration of the direction of the detected acceleration.

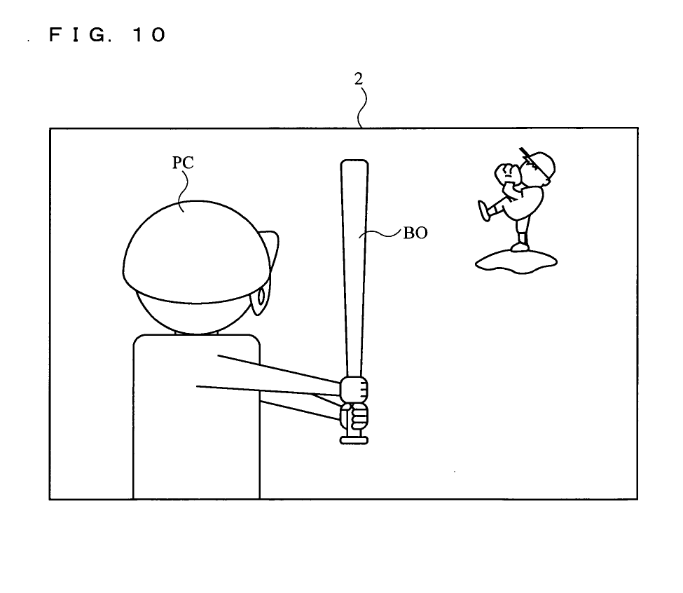

As shown in FIG. 10, a baseball game or the like is displayed on the monitor 2 in accordance with the X-, Y-, and Z-axis direction acceleration data which is received from the controller 7. Specifically, a part of a field (e.g., a baseball field) which is set in a virtual game space is displayed on the monitor 2 as a three-dimensional game image. A player character PC representing a batter operated by the player, a bat object BO held by the player character PC, an opponent character which is to play against the player character PC and the like are located in the virtual game space and displayed on the monitor 2. In order to provide a specific explanation below, it is assumed that a game program for a baseball game is stored on the optical disc 4. Among the baseball game processing executed by the CPU 30, the processing of causing the player character PC to swing the bat object BO after the bat object BO moves in the virtual game space in accordance with the inclination and the motion of the controller 7 will be described.

The player character PC holds the bat object BO, and is located on the field which is set in the virtual game space. In accordance with the motion of the player inclining or moving the controller 7, the position or posture of the bat object BO is shifted and thus the manner in which the player character PC holds up the bat object BO is changed. In accordance with the motion of the player swinging the controller 7 right and left, the player character PC swings the bat object BO. Namely, as the player holding the controller 7 performs an operation of moving the controller 7, the player character PC is displayed as performing an operation of holding up or swinging the bat object BO in a similar manner. Thus, the player enjoys a virtual game as if he/she was playing baseball while holding the controller 7 as a baseball bat.

For example, when the player moves the controller 7 rightward or leftward from the upright state, the bat object BO immediately moves in the virtual game space in accordance with such a motion of the controller 7. When the player inclines the controller 7 from the upright state, the bat object BO is inclined at a predetermined ratio in accordance with the inclination angle of the controller 7. Namely, the bat object BO immediately moves in response to the rightward or leftward movement of the controller 7, whereas gradually inclining in a delayed manner in response to the inclining motion of the controller 7. Generally in the real world, when it is attempted to move an elongate member having a certain weight with one end thereof being held or to change the inclination angle thereof with one end thereof being held, the end moves immediately but the other end moves in a delayed manner. For example, the player can quickly change the inclination angle of the controller 7. However, if the inclination angle of the bat object BO was changed as quickly in response to the change in the inclination angle of the controller 7, the player character PC would appear as if it was holding a lightweight elongate member. This would look unrealistic to the player. The inclination angle of the controller 7 is changed by a subtle motion of the hand of the player holding the controller 7. If the bat object BO reacted to this change with a high responsiveness, the motion of the bat object BO would appear unnatural even though the bat object BO is intended to be moved in compliance with the player operating the controller 7. In this embodiment, when the controller 7 is moved rightward or leftward, or inclined, one end (support position) of the bat object BO moves in immediate response to the motion of the controller 7, but the other end is moved or inclined in a delayed manner so as to gradually follow the motion of the one end. Therefore, the object representing the baseball bat can be drawn as moving or inclining naturally. Thus, a baseball game reflecting the motions applied by the player to the controller 7 can be presented.

When the player swings the controller 7 right and left, the player character PC immediately starts a motion of swinging the bat object BO in accordance with the swing motion of the controller 7. Specifically, the bat object BO, which is shifted in the position or posture in response to the motion of the controller 7 as described above, is swung as if to hit the ball thrown by the opponent player to an arbitrary position. Along a swing trajectory of the bat object BO, neither the swing start point nor a point in the middle of the swing (e.g., a ball hitting point or a point at which the bat object BO reaches a vertical plane on which the ball is present) is fixed. Therefore, when motion data on the bat object BO being swung is prepared for each trajectory, an infinite number of motion data is needed. As described later in detail, according to the present invention, one piece of reference motion data is prepared and is corrected in accordance with the swing start point and the point in the middle of the swing, to represent the motion of the bat object BO being swung.

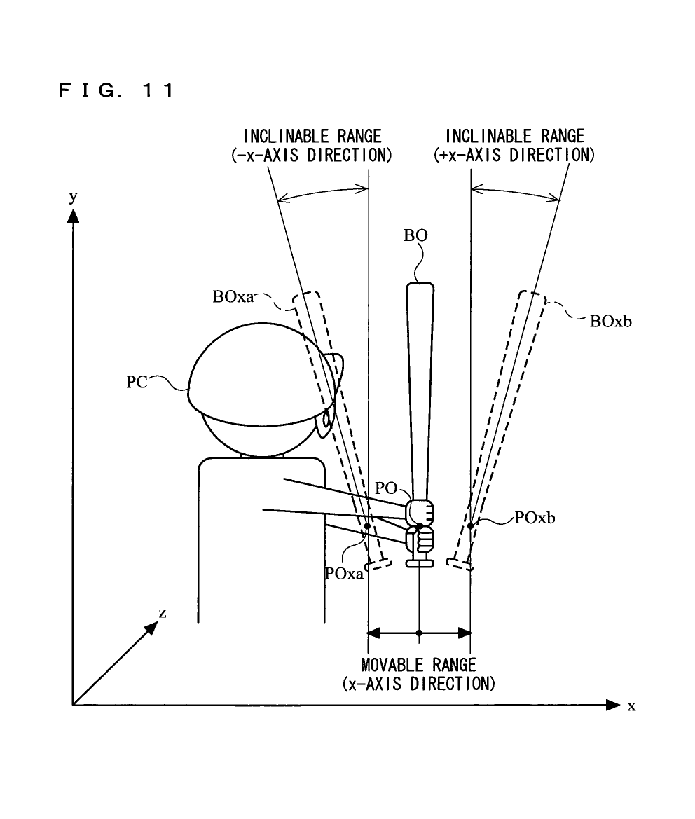

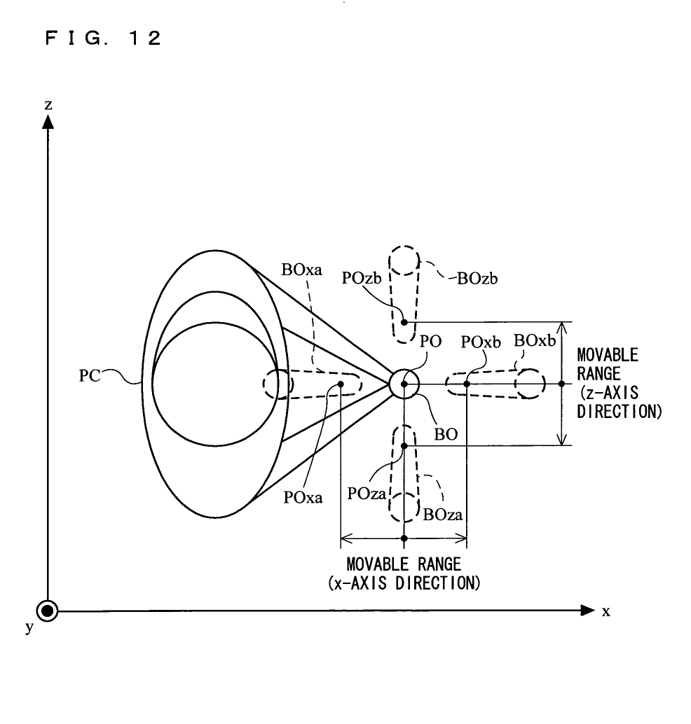

With reference to FIG. 11 and FIG. 12, an example of a movable range and an inclinable range of the bat object BO in a hold-up motion will be described. FIG. 11 shows the virtual game space in a horizontal direction in order to illustrate the hold-up motion of the bat object BO. FIG. 12 shows the virtual game space in a vertical direction from above in order to illustrate the hold-up motion of the bat object BO.

In FIG. 11 and FIG. 12, x, y and z axes perpendicular to one another are defined in the virtual game space. The x axis runs in a left-right direction of the virtual game space displayed on the monitor 2, the y axis runs in an up-down direction thereof, and the z axis runs in a depth direction thereof. A point PO representing a position of the bat object BO is provided in a part of the bat object BO (e.g., in a lower part of the bat object BO, such as the grip at which the player character PC holds the bat object BO). The position of the bat object BO in the virtual game space is represented by a coordinate set of the point PO in an x-y-z coordinate system. The inclination of the bat object BO in the virtual game space is represented by an angle at which the bat object BO is inclined with respect to the point PO (e.g., a directional vector).

A position and an inclination angle of the bat object BO, corresponding to the position and the inclination angle of the controller 7 which stands still upright with the front surface thereof being directed upward (see FIG. 9), are respectively set as the reference position and the reference inclination angle of the bat object BO. In FIG. 11 and FIG. 12, the bat object BO having the point PO at the reference position and assuming the reference inclination angle is shown by the solid line, and the bat objects BO shifted from the reference position and the reference inclination angle are shown with the dashed line. In this embodiment, the position and the inclination of the bat object BO corresponding to the controller 7 standing still upright with the front surface being directed upward as described above is used as the reference. Thus, the reference inclination angle is the positive y-axis direction (upward direction in the virtual game space).

A movable range is provided as a range in which the point PO can move in the virtual game space. The movable range has a predetermined width in the positive and negative x-axis directions (x-axis direction movable width wx described later), and a predetermined width in the positive and negative z-axis directions (z-axis direction movable width wz described later), with respect to the reference position. In this embodiment, a maximum movable range of the point PO (i.e., the maximum value/minimum value of the movable range along the x axis and the z axis) is provided in correspondence with the maximum value of acceleration detectable by the acceleration sensor 701 (e.g., 2 G for each axis). The output value from the acceleration sensor 701 is scaled to the movable range, and thus the post-movement coordinate set of the point PO in the x-y-z coordinate system is calculated. For example, the width of the movable range in the x-axis and z-axis directions with respect to the reference position is set at length 3 in the virtual game space. The acceleration in the Y-axis direction detected by the acceleration sensor 701 is made to correspond to the movement of the point PO in the x-axis direction, and the acceleration in the X-axis direction detected by the acceleration sensor 701 is made to correspond to the movement of the point PO in the z-axis direction. Where the maximum value of acceleration detectable by the acceleration sensor 701 is 2 G, the detected acceleration in the Y-axis direction is multiplied by 1.5 to scale the position of the point PO in the x-axis direction to the movable range. The detected acceleration in the X-axis direction is multiplied by 1.5 to scale the position of the point PO in the z-axis direction to the movable range. In FIG. 11 and FIG. 12, when the maximum value of acceleration in the negative Y-axis direction is detected by the acceleration sensor 701, the coordinate set of the point PO scaled accordingly to the minimum value in the x-axis direction in the movable range is represented as point POxa. When the maximum value of acceleration in the positive Y-axis direction is detected by the acceleration sensor 701, the coordinate set of the point PO scaled accordingly to the maximum value of the acceleration in the x-axis direction in the movable range is represented as point POxb. When the maximum value of acceleration in the negative X-axis direction is detected by the acceleration sensor 701, the coordinate set of the point PO scaled accordingly to the minimum value in the z-axis direction in the movable range is represented as point POza. When the maximum value of acceleration in the positive X-axis direction is detected by the acceleration sensor 701, the coordinate set of the point PO scaled accordingly to the maximum value in the z-axis direction in the movable range is represented as point POzb.

An inclinable range is provided as a range in which the bat object BO can incline in the virtual game space. The inclinable range has a predetermined angle in the positive and negative x-axis directions, and a predetermined angle in the positive and negative z-axis directions, with respect to the reference inclination angle (i.e., the positive y-axis direction). The bat object BO is drawn as inclining in the x-axis direction using the acceleration in the Y-axis direction detected by the acceleration sensor 701, and is drawn as inclining in the z-axis direction using the acceleration in the X-axis direction detected by the acceleration sensor 701. As described later, the game apparatus main body 5 calculates a target inclination for the bat object BO within the movable range, using the X-axis and Y-axis direction acceleration data which is output from the controller 7. Then, the game apparatus main body 5 draws the bat object BO with the inclination angle being changed by a predetermined ratio (e.g., 10%) from the current inclination angle toward the target inclination. In FIG. 11 and FIG. 12, the bat object BO in the state of inclining at the maximum angle in the inclinable range in the negative x-axis direction is represented as bat object BOxa. The bat object BO in the state of inclining at the maximum angle in the inclinable range in the positive x-axis direction is represented as bat object BOxb. The bat object BO in the state of inclining at the maximum angle in the inclinable range in the negative z-axis direction is represented as bat object BOza. The bat object BO in the state of inclining at the maximum angle in the inclinable range in the positive z-axis direction is represented as bat object BOzb.

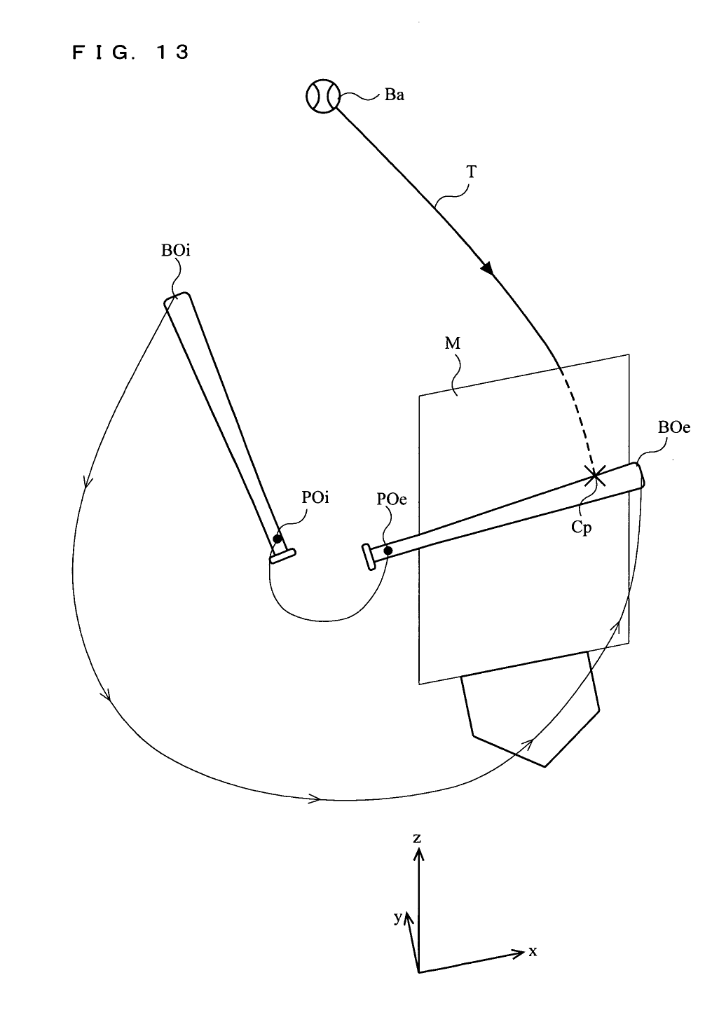

Next, with reference to FIG. 13, an exemplary motion of the bat object BO being swung will be described. FIG. 13 shows a state where the bat object BO is swung in the virtual game space. In the following exemplary swing motion, when the player merely makes a motion of swinging the controller 7, a ball object Ba which has been thrown is necessarily hit by the bat object BO (except when the swing timing of the bat object BO is not appropriate).

As shown in FIG. 13, the virtual game space includes a virtual reach determination plane M. The reach determination plane M encompasses a position, near the player character PC, at which the ball object Ba thrown by the opponent pitcher is prospected to reach. The reach determination plane M is vertical to the z axis of the virtual game space, and is provided in a space in which the player character PC can swing the bat object BO. For example, the reach determination plane M is located at a position at which the bat object BO swung by the player character PC is vertical with respect to the opponent pitcher (e.g., the front edge of the home base) and is provided vertical with respect to the centerline of the ballpark.

For example, when the opponent pitcher makes a motion of throwing the ball object Ba, a prospected trajectory T along which the ball object Ba will move in the virtual game space is calculated. The intersection of the reach determination plane M and the prospected trajectory T is calculated as a ball reach point Cp.

The ball reach point Cp is a target position for swinging the bat object BO. Specifically, when the player character PC swings the bat object BO and hits the ball object Ba on the reach determination plane M, namely hits the ball at a position where the bat object BO is vertical with respect to the opponent pitcher, the bat object BO is swung such that a predetermined position in the bat object BO (e.g., the core of the bat) contacts the ball object Ba (bat object BOe in FIG. 13). Namely, based on the ball reach point Cp of the ball object Ba, support position POe and the inclination of bat object BOe when the bat object BO is swung up to the reach determination plane M are obtained.

As described above, the swing start state of the bat object BO varies in accordance with the posture of the controller 7 held by the player (bat object BOi in FIG. 13). Namely, based on the X-, Y-, and Z-axis direction acceleration data which is output from the controller 7, support position POi and the inclination of bat object BOi at the swing start point are obtained. In accordance with the motion of the player swinging the controller 7, the bat object BO is swung from the position of bat object BOi to the position of bat object BOe.

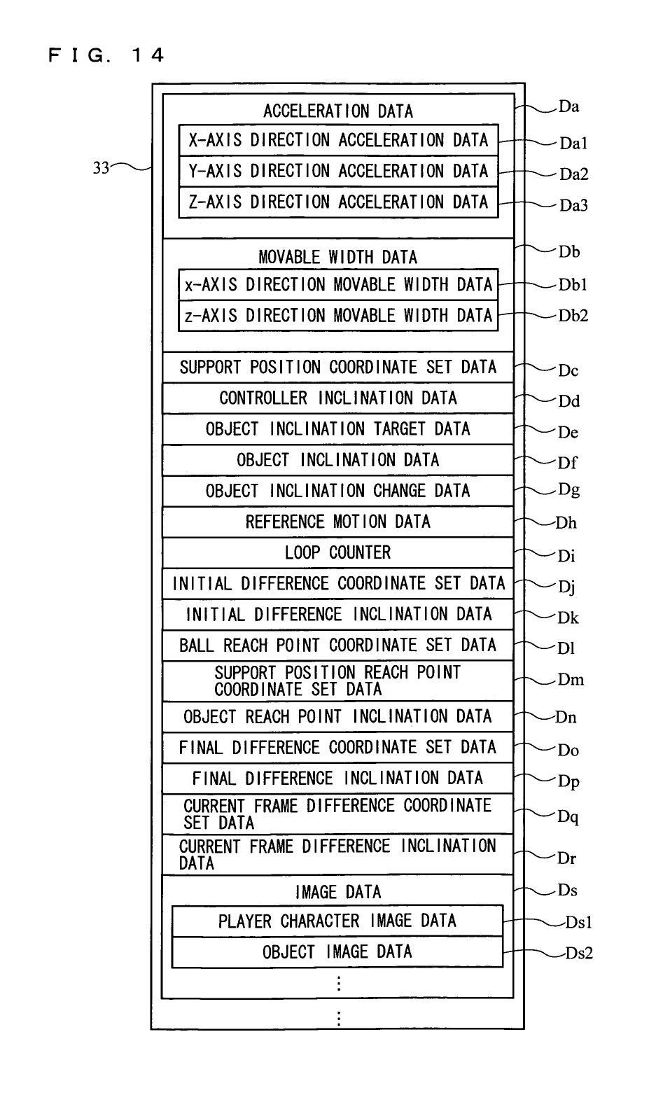

Next, the game processing executed by the game system 1 will be described in detail. With reference to FIG. 14, main data used for the game processing will be described. FIG. 14 shows main data stored on the main memory 33 of the game apparatus main body 5.

As shown in FIG. 14, the main memory 33 has stored thereon acceleration data Da, movable width data Db, support position coordinate set data Dc, controller inclination data Dd, object inclination target data De, object inclination data Df, object inclination change data Dg, reference motion data Dh, a loop counter Di, initial difference coordinate set data Dj, initial difference inclination data Dk, ball reach point coordinate set data Dl, support position reach point coordinate set data Dm, object reach point inclination data Dn, final difference coordinate set data Do, final difference inclination data Dp, current frame difference coordinate set data Dq, current frame difference inclination data Dr, image data Ds, and the like. The main memory 33 has stored thereon data regarding the player character PC, the opponent character and the like appearing in the game (position data, etc.), data regarding the virtual game space (topographical data, etc.) and other data required for the game processing as well as the data shown in FIG. 14.

The acceleration data Da is included in a series of operation information transmitted from the controller 7 as transmission data. The acceleration data Da includes X-axis direction acceleration data Da1, Y-axis direction acceleration data Da2, and Z-axis direction acceleration data Da3, each of which is detected by the acceleration sensor 701 as a component of each of X-, Y-, and Z-axes. The communication unit 6 included in the game apparatus main body 5 receives acceleration data included in the operation information which is transmitted from the controller 7 at a predetermined interval of, for example, 5 ms, and stores the acceleration data in a buffer (not shown) in the communication unit 6. Then, the acceleration data is read in units of a frame, which is a game processing interval, and thus the acceleration data Da in the main memory 33 is updated. In this embodiment, the acceleration data Da may be updated into the latest acceleration data transmitted from the controller 7. Alternatively, acceleration data of a predetermined number of previous frames may be stored.

The movable width data Db represents the width in which the point PO (support position; see FIG. 11 and FIG. 12) is movable in the virtual game space in the hold-up motion, with respect to the reference position. The movable width data Db includes x-axis direction movable width data Db1 which represents a movable width in the x-axis direction, and z-axis direction movable width data Db2 which represents a movable width in the z-axis direction, both in the hold-up motion. The support position coordinate set data Dc represents the coordinate set of the point PO in the virtual game space in the hold-up motion.

The controller inclination data Dd represents the direction of inclination of the controller 7 which is calculated using the acceleration data Da. The object inclination target data De represents the inclination target for the bat object BO, in the virtual game space in the hold-up motion, with respect to the point PO. The object inclination target data De is represented by, for example, a directional vector. The object inclination data Df represents an angle at which the bat object BO is drawn as inclining in the virtual game space in the hold-up motion, with respect to the point PO. The object inclination data Df is represented by, for example, a directional vector. The object inclination change data Dg represents a shift of the inclination of the bat object BO in the hold-up motion, and is represented by, for example, a shift vector representing a shift of the directional vector.

The reference motion data Dh is used as reference of a motion of swinging the bat object BO from the swing start point to the swing termination point. The reference motion data Dh represents, for example, positions of the bat object BO during the swing from the swing start point to the swing termination point (e.g., the trajectory of the support position PO from the swing start point to the swing termination point), and inclinations of the bat object BO during the swing from the swing start point to the swing termination point (e.g., a directional vector change representing the inclination change of bat object BOr from the swing start point to the swing termination point). The loop counter Di represents the time counted as time passes from the swing start point to the swing termination point of the bat object BO.

The initial difference coordinate set data Dj represents a difference between (a) the coordinate set of support position POri at the swing start point of bat object BOr in the reference motion data Dh and (b) the coordinate set of support position POi of bat object BO in the hold-up motion. The initial difference inclination data Dk represents a difference between (a) the directional vector representing an inclination of bat object BOr at the swing start point in the reference motion data Dh and (b) the directional vector representing an inclination of bat object BO in the hold-up motion.

The ball reach point coordinate set data Dl represents the coordinate set of the ball reach point Cp (see FIG. 13) in the virtual game space. The support position reach point coordinate set data Dm represents the coordinate set of support position POe (see FIG. 13) calculated in correspondence with the ball reach point Cp. The object reach point inclination data Dn represents the directional vector representing an inclination of bat object BOe calculated in correspondence with the ball reach point Cp.

The final difference coordinate set data Do represents a difference between (a) the coordinate set of support position POre when bat object BOr is on the reach determination plane M in the reference motion data Dh and (b) the coordinate set of support position POe. The final difference inclination data Dp represents a difference between (a) the directional vector representing an inclination of bat object BOr when bat object BOr matches the reach determination plane M in the reference motion data Dh and (b) the directional vector representing an inclination of bat object BOe calculated based on the ball reach point Cp.

The current frame difference coordinate set data Dq represents a difference between (a) the coordinate set of support position POr of bat object BOr in the reference motion data Dh in the current frame and (b) the coordinate set of the support position PO of the bat object BO displayed in the current frame. The current frame difference inclination data Dr represents a difference between (a) the directional vector representing an inclination of bat object BOr in the reference motion data Dh in the current frame and (b) the directional vector representing an inclination of the bat object BO displayed in the current frame.

The image data Ds includes, for example, player character image data Ds1 and object image data Ds2. The image data Ds is used for locating the player character PC and the bat object BO in the virtual game space to generate a game image.

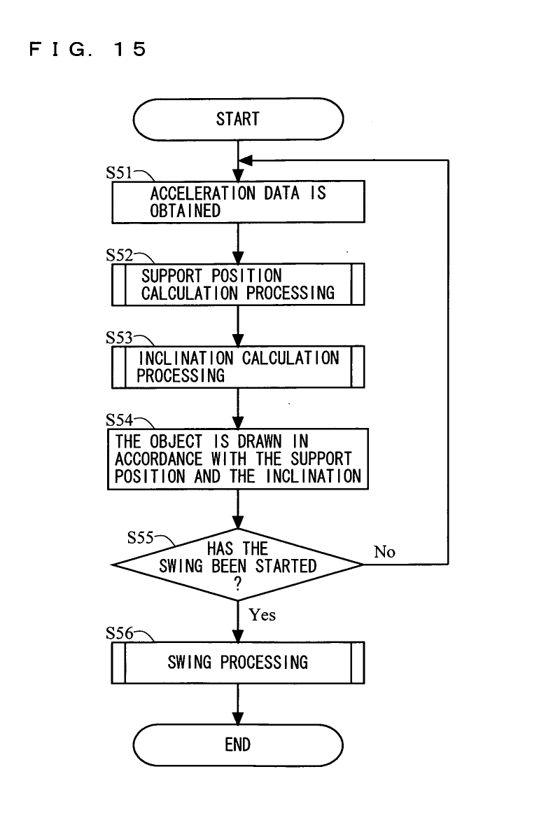

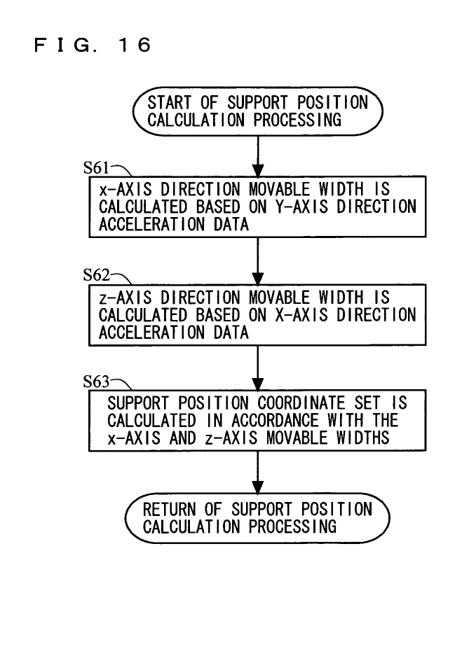

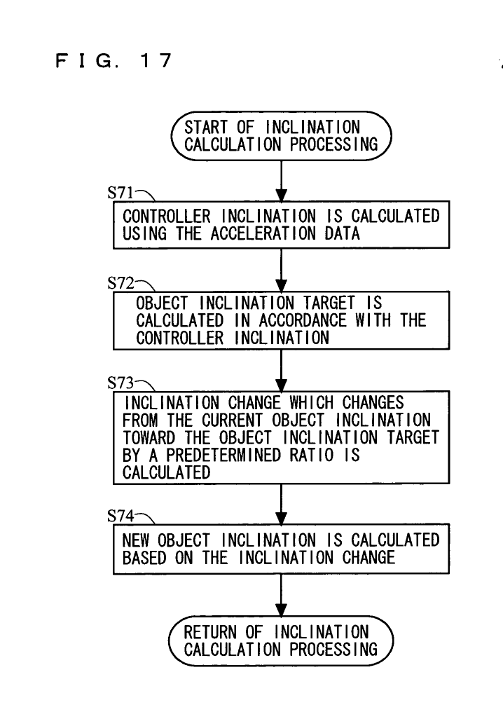

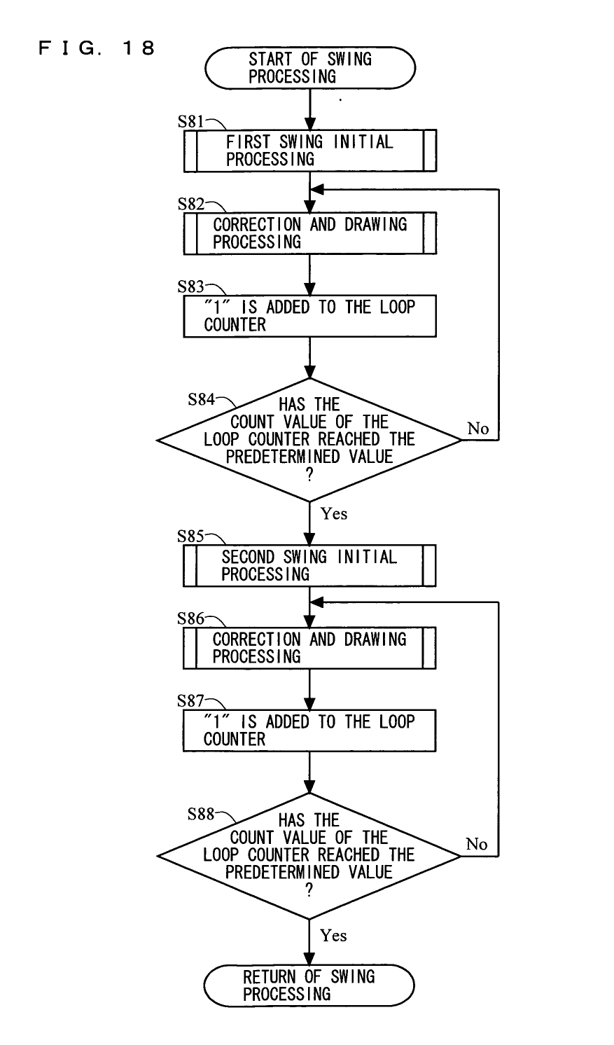

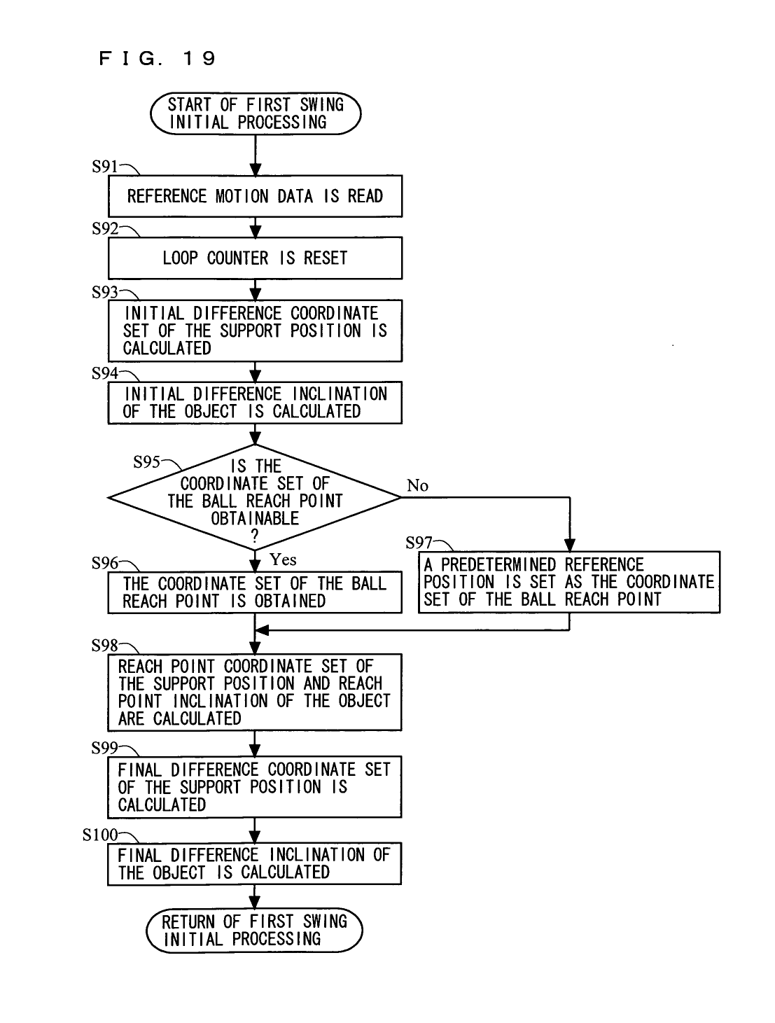

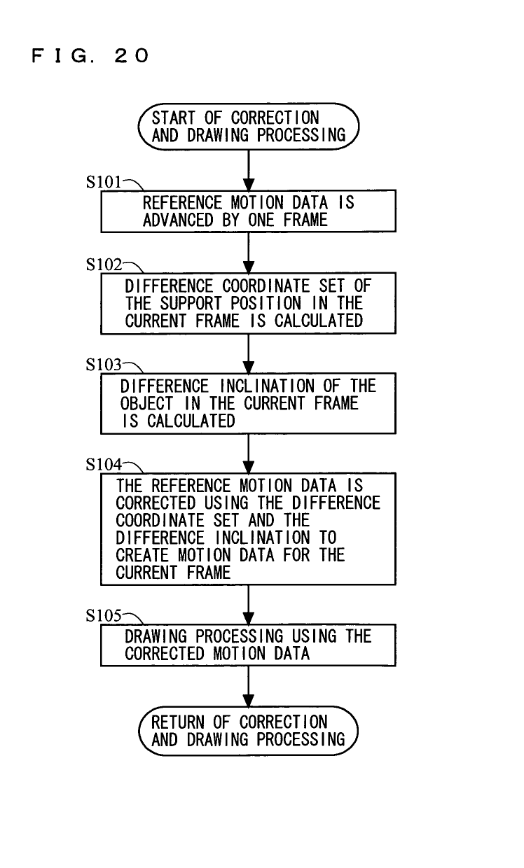

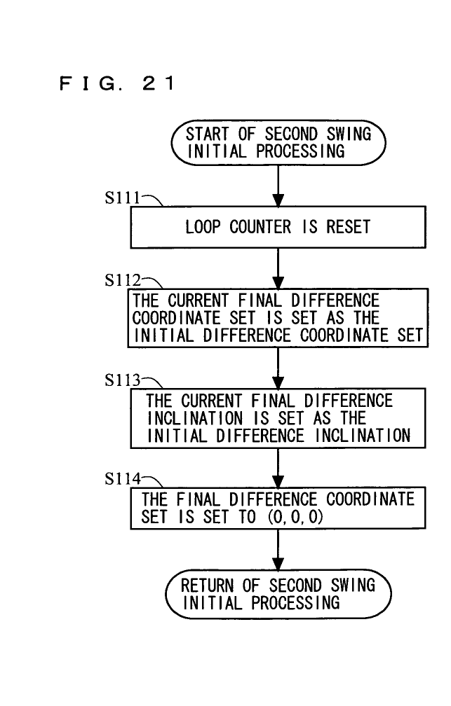

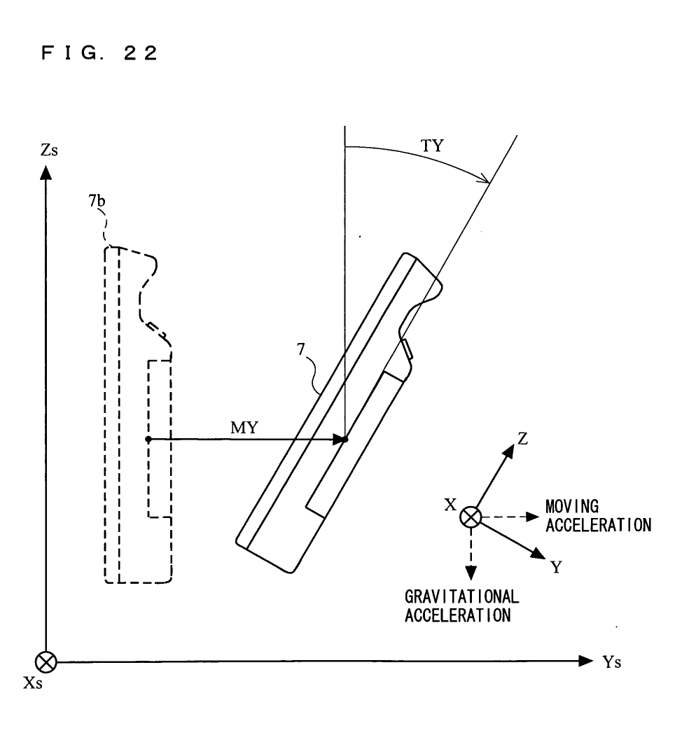

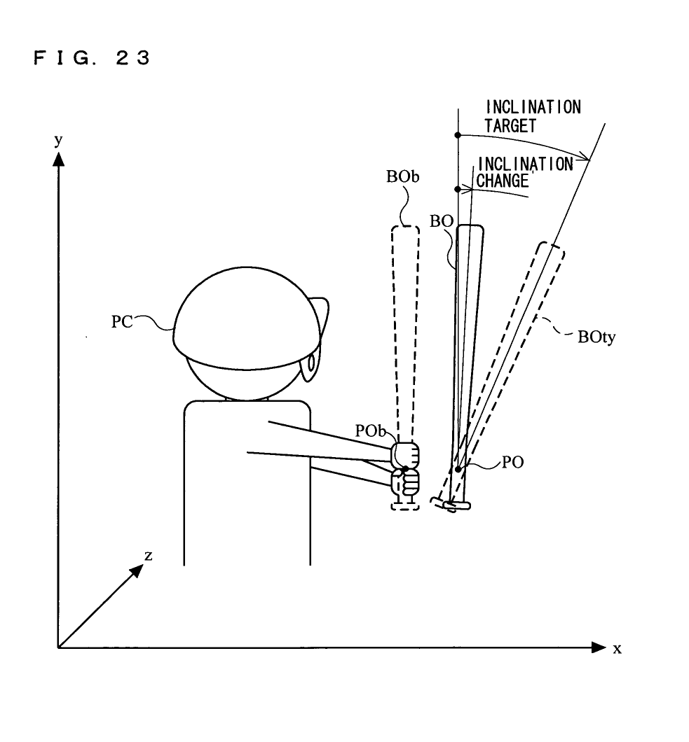

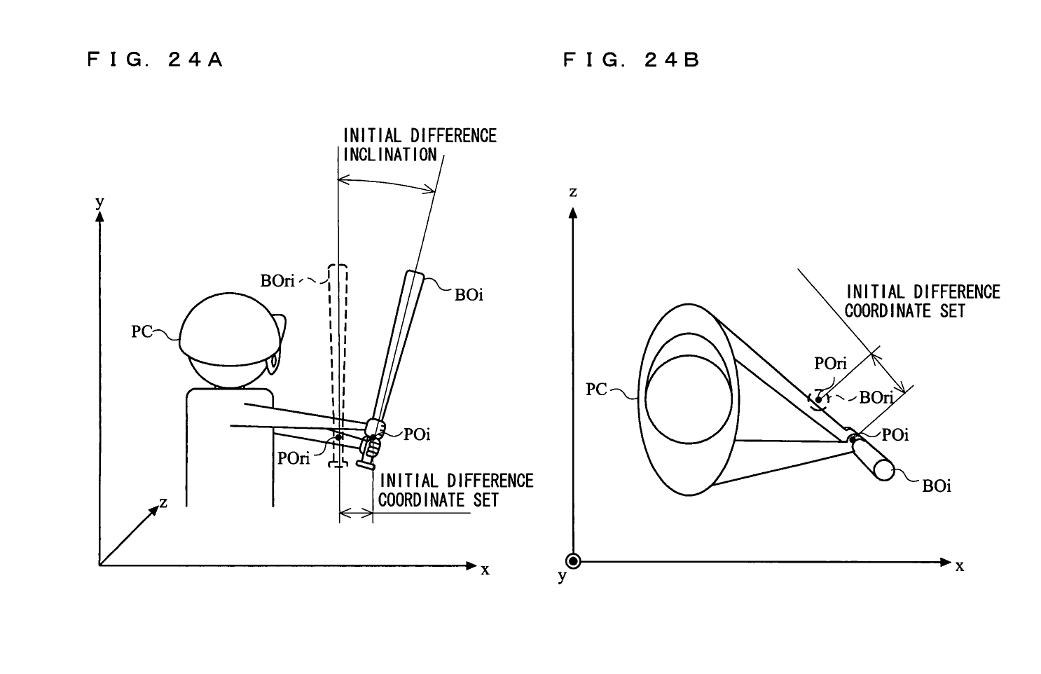

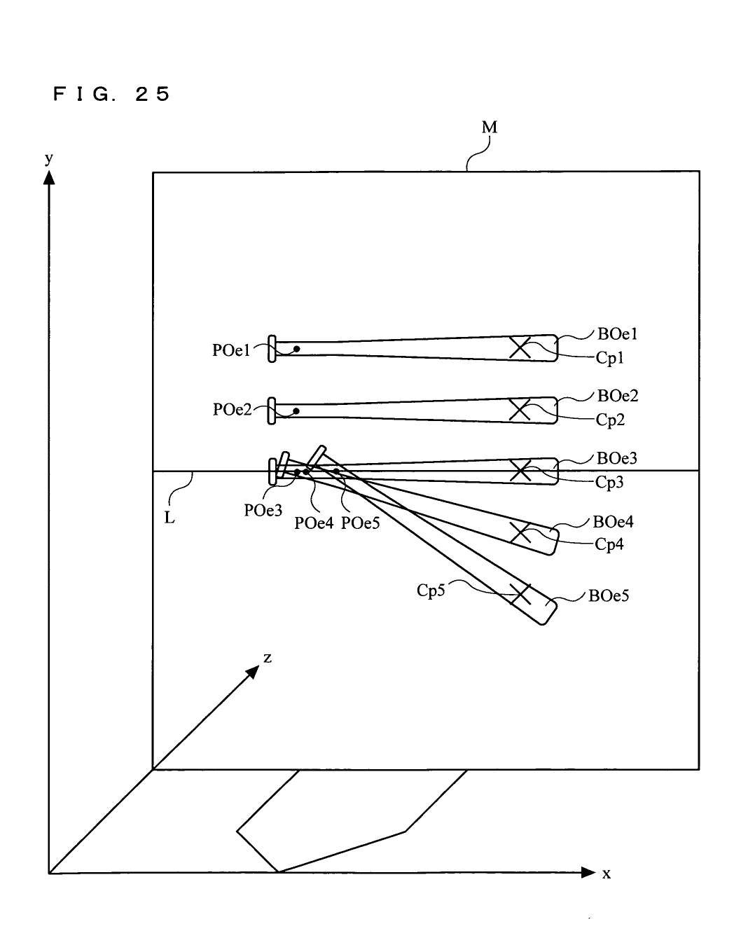

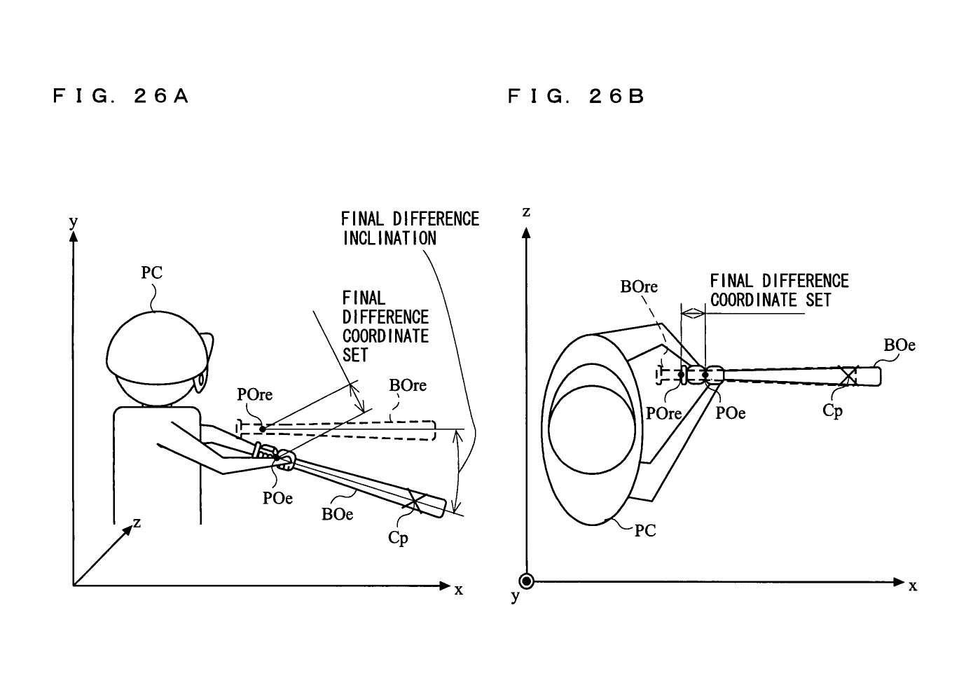

With reference to FIG. 15 through FIG. 26B, the game processing executed by the game apparatus main body 5 will be described in detail. FIG. 15 is a flowchart illustrating a flow of the game processing executed by the game apparatus main body 5. FIG. 16 is a flowchart illustrating a subroutine of support position calculation processing in step 52 shown in FIG. 15 in detail. FIG. 17 is a flowchart illustrating a subroutine of inclination calculation processing in step 53 shown in FIG. 15 in detail. FIG. 18 is a flowchart illustrating a subroutine of swing processing in step 56 shown in FIG. 15 in detail. FIG. 19 is a flowchart illustrating a subroutine of first swing initial processing in step 81 shown in FIG. 18 in detail. FIG. 20 is a flowchart illustrating a subroutine of correction and drawing processing in steps 82 and 86 shown in FIG. 18 in detail. FIG. 21 is a flowchart illustrating a subroutine of second swing initial processing in step 85 shown in FIG. 18 in detail. FIG. 22 shows an exemplary state of the controller 7 inclined from the upright state. FIG. 23 shows an exemplary state of the bat object BO shifted in position and inclination during the hold-up motion. FIG. 24A shows an exemplary state of bat object BOi at the swing start point seen in the horizontal direction of the virtual game space. FIG. 24B shows the exemplary state of bat object BOi at the swing start point seen in the vertical direction from above of the virtual game space. FIG. 25 shows an exemplary setting of support position POe and the inclination of bat object BOe corresponding to the ball reach point Cp. FIG. 26A shows an exemplary state of bat object BOe corresponding to the ball reach point Cp seen in the horizontal direction of the virtual game space. FIG. 26B shows the exemplary state of bat object BOe corresponding to the ball reach point Cp seen in the vertical direction from above of the virtual game space. The flowcharts in FIG. 15 through FIG. 21 illustrate the processing of drawing the object executed in accordance with the operation by player of moving or inclining the controller 7, among the game processing executed by the game apparatus main body 5. The other game processing which is not directly relevant to the present invention will not be described in detail. In FIG. 15 through FIG. 21, the “steps” of the processing executed by the CPU 30 will be referred to simply as

When the game apparatus main body 5 is turned on, the CPU 30 of the game apparatus main body 5 executes a start program stored on a boot ROM (not shown) to initialize the elements including the main memory 33. The game program stored on the optical disc 4 is read to the main memory 33, and thus the CPU 30 starts executing the game program. The flowcharts shown in FIG. 15 through FIG. 21 illustrate the game processing executed after the above-described processing is completed.

With reference to FIG. 15, the CPU 30 obtains acceleration data included in the operation information received from the controller 7 (step 51), and advances the processing to the next step. The CPU 30 stores the obtained acceleration data in the main memory 33 as the acceleration data Da. The acceleration data obtained in step 51 includes X-, Y- and Z-axis direction acceleration data detected by the acceleration sensor 701 as a component of each of X-, Y-, and Z-axes. The communication section 75 transmits the operation information to the game apparatus main body 5 at a predetermined time interval (e.g., every 5 ms), and thus at least the acceleration data is stored in the buffer (not shown) included in the communication unit 6. The CPU 30 obtains the acceleration data stored in the buffer and stores the acceleration data in the main memory 33, in units of a frame as a game processing interval.

Next, the CPU 30 executes support position calculation processing (step 52), and advances the processing to the next step. Hereinafter, with reference to FIG. 16, the support position calculation processing in step 52 will be described.

Referring to FIG. 16, the CPU 30 calculates an x-axis direction movable width wx based on the Y-axis direction acceleration data Da2 obtained in step 51 (step 61). Then, the CPU 30 stores the calculated x-axis direction movable width wx in the main memory 33 as the x-axis direction movable width data Db1, and advances the processing to the next step. As described above, the CPU 30 sets the maximum movable range in correspondence with the maximum value of acceleration detectable by the acceleration sensor 701, and scales the acceleration data detected by the acceleration data sensor 701 to the movable range. For example, where the maximum value of acceleration detectable by the acceleration sensor 701 is 2 G and the width of the movable range in the x-axis and z-axis directions with respect to the reference position is length 3, the CPU 30 calculates the x-axis direction movable width wx by multiplying the acceleration data represented by the Y-axis direction acceleration data Da2 by 1.5.

Next, the CPU 30 calculates a z-axis direction movable width wz based on the X-axis direction acceleration data Da1 obtained in step 51 (step 62). Then, the CPU 30 stores the calculated z-axis direction movable width wz in the main memory 33 as the z-axis direction movable width data Db2, and advances the processing to the next step. For example, where the maximum value of acceleration detectable by the acceleration sensor 701 is 2 G and the width of the movable range in the x-axis and z-axis directions with respect to the reference position is length 3, the CPU 30 calculates the z-axis direction movable width wz by multiplying the acceleration data represented by the X-axis direction acceleration data Da1 by 1.5.

Next, the CPU 30 calculates a support position coordinate set in accordance with the calculated x-axis direction movable width wx and z-axis direction movable width wz (step 63). Then, the CPU 30 stores the calculated support position coordinate set in the main memory 33 as the support position coordinate set data Dc, and terminates the processing in this subroutine. For example, where the coordinate set of the reference position in the virtual game space is (x0, y0, z0), the CPU 30 sets the support position coordinate set at (x0+wz, y0, z0+wz).

With reference to FIG. 22 and FIG. 23, the relationship between the motion of the controller 7 and the support position will be described. FIG. 22 shows the controller 7 located in the space on the side of the display screen of the monitor 2 seen in the direction toward the display screen (i.e., the display screen of the monitor 2 is present beyond the controller 7; same as in FIG. 9). FIG. 23 shows the player character PC and the bat object BO displayed on the monitor 2. As is clear from comparing FIG. 22 with FIG. 23, when it is assumed that the virtual game space represented on the monitor 2 exists in the real space where the player is present, the positive Ys-axis direction of the real space, which is the rightward direction for the player facing the display screen of the monitor 2, is the same as the positive x-axis direction which is the rightward direction of the virtual game space. The positive Zs-axis direction in the real space, which is the upward direction with respect to the player, is the same as the positive y-axis direction which is the upward direction in the virtual game space. The positive Xs-axis direction of the real space, which is from the player toward the monitor 2, is the same as the positive z-axis direction which is the depth direction of the virtual game space.

Now, it is assumed that the controller 7, which is in a state of standing upright with the top surface being directed in the negative Ys-axis direction and the front surface being directed in the positive Zs-axis direction (controller 7b represented by the dashed line in FIG. 22), is moved by distance MY in the positive Ys-axis direction and inclined by angle TY in the positive Ys-axis direction (the controller 7 represented by the solid line in FIG. 22). With controller 7b standing upright, the acceleration in the X-axis direction and the acceleration in the Y-axis direction are both 0, and a gravitational acceleration in the negative Z-axis direction is detected (see FIG. 9). The controller 7 detects an acceleration generated by the movement by distance MY (moving acceleration) and a change in the gravitational acceleration caused by the inclination by angle TY. Specifically, as shown in FIG. 22, the acceleration sensor 701 of the controller 7 detects a moving acceleration generated in a direction between the positive Y-axis direction and the positive Z-axis direction, and a gravitation acceleration generated in a direction between the positive Y-axis direction and the negative Z-axis direction. As a result, the acceleration sensor 701 detects an acceleration in the positive Y-axis direction as a sum of the Y-axis direction component of the moving acceleration and the Y-axis direction component of the gravitational acceleration. The acceleration detected by the acceleration sensor 701 in the X-axis direction is 0.

By the above-described operation, the support position coordinate set is scaled using the x-axis direction movable width ws calculated based on the Y-axis direction acceleration data. For example, the support position, which is at the position corresponding to the upright state, is moved in the positive x-axis direction in accordance with the acceleration in the positive Y-axis direction described above (is moved from the position of point POb to the position of the point PO in FIG. 23). Namely, when the controller 7 moves, the support position immediately moves in the same direction (in the example of FIG. 22 and FIG. 23, in the positive x-axis direction in the virtual game space, which is the same as the positive Ys-axis direction in the real space)

Returning to FIG. 15, the CPU 30 executes inclination calculation processing (step 53), and advances the processing to the next step. Hereinafter, with reference to FIG. 17, the inclination calculation processing in step 53 will be described.

Referring to FIG. 17, the CPU 30 calculates the current inclination of the controller 7 based on the acceleration data Da1 obtained in step 51 (step 71). Then, the CPU 30 stores the calculated inclination of the controller 7 in the main memory 33 as the controller inclination data Dd, and advances the processing to the next step. For example, when the acceleration sensor 701 detects a static acceleration (gravitational acceleration), the inclination of the controller 7 with respect to the gravitational vector can be calculated by performing calculations using the output from the acceleration sensor 701. When the acceleration sensor 701 also detects a dynamic acceleration (moving acceleration), it is difficult to find an accurate inclination of the controller 7. In this embodiment, the inclination of the controller 7 may be obtained by regarding the dynamic acceleration also as the static acceleration. As described later in detail, when an acceleration equal to or greater than a threshold level is applied in the Z-axis direction, other processing is executed.

The CPU 30 calculates an inclination target for the bat object BO in accordance with the inclination of the controller 7 calculated in step 71 (step 72; see FIG. 23). Then, the CPU 30 stores the calculated inclination target in the main memory 33 as the object inclination target data De, and advances the processing to the next step. For example, the CPU 30 calculates a directional vector in the virtual game space, which is converted from the inclination of the controller 7 in the real space, and sets the directional vector as the object inclination target.

Next, the CPU 30 calculates an inclination change representing a shift of the current object inclination toward the inclination target by a predetermined ratio (step 73; see FIG. 23). Then, the CPU 30 stores the calculated inclination change in the main memory 33 as the object inclination change data Dg, and advances the processing to the next step. For example, the CPU 30 calculates a moving vector representing a shift from the directional vector, which represents the current inclination of the bat object BO stored as the object inclination data Df, toward the directional vector, which represents the inclination target, by a predetermined ratio (e.g., 10%). Then, the CPU 30 sets the moving vector as the inclination change.

Next, the CPU 30 calculates a new object inclination based on the inclination change calculated in step 73 (step 74). Then, the CPU 30 stores the calculated object inclination in the main memory 33 as the object inclination data Df, and terminates the processing in this subroutine.

With reference to FIG. 22 and FIG. 23, the relationship between the inclination of the controller 7 and the object inclination will be described. For example, when the controller 7 is stopped still in the state of inclining by angle TY as shown in FIG. 22, the acceleration sensor 701 of the controller 7 detects a static gravitational acceleration generated in a direction between the positive Y-axis direction and the negative Z-axis direction. The CPU 30 finds that the controller 7 is inclined toward the positive Ys-axis direction by angle TY with respect to the positive Zs-axis direction (the upward direction in the real space), in accordance with the output from the acceleration sensor 701 which detected the gravitational acceleration. Next, the CPU 30 calculates an inclination target at which the bat object BO would appear inclined toward the positive x-axis direction by angle TY with respect to the positive y-axis direction. The inclination target is obtained in the virtual game space as a result of conversion from the inclination of the controller 7. Then, the CPU 30 changes the current inclination of the bat object BO (bat object BOb represented by the dashed line in FIG. 23) toward the inclination target (bat object BOty represented by the dashed line in FIG. 23) by the predetermined ratio (as a result, the bat object BO represented by the solid line in FIG. 23 is obtained).

In this manner, the bat object BO is drawn as inclining in the virtual game space in accordance with the inclination of the controller 7, like in the case of the movement of the support position (point PO). For example, if the bat object BO was drawn reflecting the above inclination target as it is, the bat object BO would be drawn as inclining in immediately response to the inclination of the controller 7, i.e., as bat object BOty represented by the dashed line in FIG. 23. However, in this embodiment, the bat object BO is not drawn as inclining by the same amount as the change amount of the inclination of the controller 7, but is drawn as inclining by a predetermined ratio (e.g., 10%) of the change amount of the controller 7. Namely, as the player inclines the controller 7, the bat object BO reacts in a delayed manner so as to be gradually inclined. Therefore, the baseball bat appears moving or inclining naturally. Thus, a baseball game reflecting the motions applied by the player to the controller 7 can be presented.

As described above, the inclinable range is set for the bat object BO. Therefore, it is necessary to accommodate the object inclination within the inclinable range during any of steps 72 through 74. For example, in step 72, the CPU 30 may set, as the inclination target, a direction in the inclinable range which is closest to the direction in the virtual game space converted from the inclination of the controller 7. In step 73 or 74, the CPU 30 may calculate an inclination change or a new object inclination such that the object inclination is accommodated within the inclinable range.

Returning to FIG. 15, the CPU 30 draws the bat object BO on the monitor 2 in accordance with the support position and the current object inclination (step 54), and advances the processing to the next step. Specifically, the CPU 30 refers to the support position coordinate set data Dc and the object inclination data Df to obtain a directional vector representing the support position coordinate set (coordinate set of point PO) of the bat object BO and the inclination direction of the bat object BO. Then, the CPU 30 draws the player character PC holding up the bat object BO on the display screen of the monitor 2 using the image data Dh and the like.

Next, the CPU 30 determines whether or not the player has made an operation of starting a motion of swinging the bat (step 55). For example, the operation of starting the motion of swinging the bat is performed by the player swinging the controller 7 right and left. In this case, the CPU 30 can determine whether or not the player has started swinging the controller 7 by determining whether or not the magnitude of the acceleration in the positive Z-axis direction which is output from the acceleration sensor 701 is equal to or greater than a predetermined value. When it is determined that the player has not made an operation of starting the motion of swinging the bat, the CPU 30 returns the processing to step 51 to repeat the above-described processing. By contrast, when it is determined that the player has made an operation of starting the motion of swinging the bat, the CPU 30 advances the processing to step 56.

In step 56, the CPU 30 executes swing processing and then terminates the processing in the flowchart in FIG. 15. Hereinafter, with reference to FIG. 18 through FIG. 21, the swing processing in step 56 will be described.

Referring to FIG. 18, the CPU 30 executes first swing initial processing (step 81), and advances the processing to the next step. With reference to FIG. 19, the first swing initial processing in step 81 will be described.

Referring to FIG. 19, the CPU 30 reads the reference motion data Dh (step 91), and resets the count value of the loop counter Di (e.g., resets the count value to 0) (step 92). The CPU 30 calculates an initial difference coordinate set of the support position PO (step 93) and an initial difference inclination of the bat object BO (step 94), and advances the processing to the next step. Hereinafter, with reference to FIG. 24A and FIG. 24B, the initial difference coordinate set and the initial difference inclination will be described.

Referring to FIG. 24A and FIG. 24B, the CPU 30 compares (a) the current support position PO and the object inclination of the current bat object BO (i.e., the support position and the inclination in the hold-up state) with (b) the support position PO and the object inclination of the bat object BO at the swing start point in the reference motion data Dh, and obtains the respective differences. In FIG. 24A and FIG. 24B, the current support position PO and the current bat object BO are represented as support position POi and bat object BOi. Bat object BOi is represented by the solid line. The support position PO and the bat object BO at the swing start point in the reference motion data Dh are represented as support position POri and bat object BOri. Bat object BOri is represented by the dashed line.

The CPU 30 calculates a difference between support position POri in the reference motion data Dh and current support position POi as an initial difference coordinate set, and stores the result in the initial difference coordinate set data Dj. For example, the initial difference coordinate set is represented by a difference in each of the x coordinate, the y coordinate and the z coordinate between support position POri and support position POi in the virtual game space. The CPU 30 also calculates a difference between the object inclination of bat object BOri in the reference motion data Dh and the object inclination of current bat object BOi as an initial difference inclination, and stores the result in the initial difference inclination data Dk. For example, the initial difference inclination is represented by a directional vector in the virtual game space.

Next, the CPU 30 determines whether or not the coordinate set of the ball reach point Cp (see FIG. 13) in the virtual game space is obtainable (step 95). As described above, the ball reach point Cp is obtained, when the prospected trajectory T along which the ball object Ba moves in the virtual game space, by calculating the intersection of the prospected trajectory T and the reach determination plane M. Namely, when the prospected trajectory T is obtained (e.g., when the opponent pitcher has made a motion of throwing the ball object Ba), the CPU 30 determines that the coordinate set of the ball reach point Cp is obtainable and advances the processing to step 96. By contrast, when the prospected trajectory T is not obtained (e.g., when the player character PC makes a practice swing of the bat object BO), the CPU 30 determines that coordinate set of the ball reach point Cp is not obtainable and advances the processing to step 97.

In step 96, the CPU 30 calculates the coordinate set of the ball reach point Cp and stores the result in the ball reach point data Dl. Then, the CPU 30 advances the processing to step 98. Specifically, as shown in FIG. 13, the CPU 30 first calculates the prospected trajectory T along which the ball object Ba moves in the virtual game space in accordance with the motion of the opponent pitcher throwing the ball object Ba (type, speed, control and the like of the ball). Then, the CPU 30 calculates the intersection of the prospected trajectory T and the reach determination plane M, and obtains the coordinate set of the ball reach point Cp (ball reach point coordinate set) in the virtual game space.

In step 97, the CPU 30 stores a predetermined reference position in the ball reach point coordinate set data Dl as the ball reach point coordinate set, and advances the processing to step 98. For example, the CPU 30 sets, as the reference position, a point on the reach determination plane M which is, for example, the exact center of the strike zone in the baseball game.

In step 98, the CPU 30 calculates the reach point coordinate set of the support position PO and the reach point inclination of the bat object BO, and stores the respective results in the support position reach point coordinate set data Dm and the object reach point inclination data Dn. Then, the CPU 30 advances the processing to the next step. Hereinafter, with reference to FIG. 25, the reach point coordinate set of the support position PO and the reach point inclination of the bat object BO will be described.

Referring to FIG. 25, as described above, the ball reach point Cp is usable as the target position for swinging the bat object BO. Specifically, the bat object BO is swung such that the ball object Ba which has reached the ball reach point Cp is hit by a predetermined position (e.g., the core) in the bat object BO which is parallel to the reach determination plane M. Namely, the bat object BO in this state is located on the reach determination plane M. The support position PO and the bat object BO corresponding to the ball reach point Cp are respectively represented as support position POe and bat object BOe.

On the reach determination plane M, a high-low determination line L which is parallel to the x axis is set. The high-low determination line L is the border representing the lower limit for the bat object BO which is level-swung (swung horizontally) by the player character PC. The high-low determination line L is set at the height of, for example, the armpit of the player character PC or the vicinity thereof.

In the case where the ball reach point Cp is set on the reach determination plane M at a height equal to or above the high-low determination line L (ball reach points Cp1 through Cp3 in FIG. 25), bat object BOe corresponding to such a ball reach point Cp is set to a position which is horizontal to the reach determination plane M and at which the ball reach point Cp is the core of the bat (i.e., a position parallel to the x axis) (bat objects BOe1 through BOe3 in FIG. 25). Since the length from the core of the bat object BO to support position POe is constant, the position of support position POe can be calculated (support positions POe1 through POe3 in FIG. 25). Thus, the position and the inclination of bat object BOe are uniquely determined. As a result, support position POe and the inclination of bat object BOe corresponding to the ball reach point Cp are determined.

In the case where the ball reach point Cp is set on the reach determination plane M at a height below the high-low determination line L (ball reach points Cp4 and Cp5 in FIG. 25), bat object BOe corresponding to such a ball reach point Cp is set to a position at which the ball reach point Cp is the core of the bat, at which support position COe is on the high-low determination line L, and which is horizontal to the reach determination plane M (bat objects BOe4 and BOe5 in FIG. 25). Since the length from support position POe to the core of the bat object BO is constant, the position of support position POe located on the high-low determination line L can be calculated using the ball reach point Cp and the length (support positions POe4 and POe5 in FIG. 25). Thus, the position and the inclination of bat object BOe are uniquely determined. As a result, support position POe and the inclination of bat object BOe corresponding to the ball reach point Cp are determined.

Next, the CPU 30 calculates the final difference coordinate set of the support position PO (step 99) and the final difference inclination of the bat object BO (step 100), and then terminates the processing in this subroutine. Hereinafter, with reference to FIG. 26A and FIG. 26B, the final difference coordinate set and the final difference inclination will be described.

Referring to FIG. 26A and FIG. 26B, the CPU 30 compares (a) the support position PO and the object inclination of the bat object BO corresponding to the ball reach position Cp with (b) the support position PO and the object inclination of the bat object BO located on the reach determination plane M in the reference motion data Dh, and obtains the respective differences. In FIG. 26A and FIG. 26B, the support position PO and the bat object BO corresponding to the ball reach point Cp are represented as support position POe and bat object BOe. Bat object BOe is represented by the solid line. The support position PO and the bat object BO located on the reach determination plane M in the reference motion data Dh are represented as support position POre and bat object BOre. Bat object BOre is represented by the dashed line.

The CPU 30 calculates a difference between support position POre in the reference motion data Dh and support position POe corresponding to the ball reach point Cp as a final difference coordinate set, and stores the result in the final difference coordinate set data Do. For example, the final difference coordinate set is represented by a difference in each of the x coordinate, the y coordinate and the z coordinate between support position POre and support position POe in the virtual game space. The CPU 30 also calculates a difference between the object inclination of bat object BOre in the reference motion data Dh and the object inclination of bat object BOe corresponding to the ball reach point Cp as a final difference inclination, and stores the result in the final difference inclination data Dp. For example, the final difference inclination is represented by a directional vector in the virtual game space.

Returning to FIG. 18, after the first swing initial processing (step 81), the CPU 30 executes correction and drawing processing (step 82), and advances the processing to the next step. With reference to FIG. 20, the correction and drawing processing in step 82 will be described.

Referring to FIG. 20, the CPU 30 advances the reference motion data Dh read in step 91 by one frame ( 1/60 sec.) (step 101) and calculates a difference coordinate set of the support position PO in the current frame (step 102). Then, the CPU 30 advances the processing to the next step. Specifically, the difference coordinate set of the support position PO is calculated by the following expression for each of the x coordinate, the y coordinate and the z coordinate in the virtual game space.

Difference coordinate set=initial difference coordinate set+(final difference coordinate set−initial difference coordinate set)×Fn/Fa

The calculated difference coordinate set of the support position PO is stored in the current frame difference coordinate set data Dq. In the expression, the initial difference coordinate set is the difference value stored in the initial difference coordinate set data Dj regarding each of the x coordinate, the y coordinate and the z coordinate. The final difference coordinate set is the difference value stored in the final difference coordinate set data Do regarding each of the x coordinate, the y coordinate and the z coordinate. Fn is the frame number of the current frame. As the action which is the target of the correction and drawing processing proceeds frame to frame, the frame number is incremented. The frame number is 0 at the start of the action. Fa is the total number of frames, which is the number of frames from the start to the termination of the action. For example, the total frame number is the number of frames from the swing start until the bat object BO reaches the reach determination plane M, or the number of frames from when the bat object BO is located on the reach determination plane M until the swing termination.

Next, the CPU 30 calculates the difference inclination of the bat object BO in the current frame (step 103), and advances the processing to the next step. Specifically, the difference inclination of the bat object BO is represented as a directional vector in the virtual game space and is calculated by the following expression.

Difference inclination=initial inclination+(final inclination−initial inclination)×Fn/Fa

The calculated difference inclination of the bat object BO is stored in the current frame difference inclination data Dr. In the expression, the initial difference inclination is the directional vector stored in the initial difference inclination data Dk. The final difference inclination is the directional vector stored in the final difference inclination data Dp. Fn is the frame number of the current frame, and Fa is the total number of frames, as described above regarding step 102.

Next, the CPU 30 corrects the reference motion data Dh in the current frame using the difference coordinate set calculated in step 102 and the difference inclination calculated in step 103, and creates motion data for the current frame (step 104). Then, the CPU 30 draws the player character PC swinging the bat object BO, using the motion data created in step 104 (step 105), and terminates the processing in this subroutine. Thus, the bat object BO is displayed while the differences in the display position and the inclination of the bat object BO to be actually drawn, with respect to the reference display position and the reference inclination, are gradually changed as time passes from the differences at the start of the correction until the differences at the termination of the correction.

Returning to FIG. 18, after the correction and drawing processing (step 82), the CPU 30 adds “1” to the count value of the loop counter Di (step 83), and determines whether or not the count value has reached a predetermined value (step 84). As the predetermined value, the number of times that the processing in step 82 is repeated from the swing start until the bat object BO reaches the reach determination plane M is used. When it is determined that the count value has reached the predetermined value, the CPU 30 advances the processing to step 85. By contrast, when it is determined that the count value has not reached the predetermined value, the CPU 30 returns the processing to step 82 to repeat the processing.

In step 85, the CPU 30 executes second swing initial processing, and advances the processing to the next step. With reference to FIG. 21, the second swing initial processing in step 85 will be described.

Referring to FIG. 21, the CPU 30 resets the count value of the loop counter Di (e.g., resets to 0) (step 111). Next, the CPU 30 updates the initial difference coordinate set data Dj with the difference (x, y and z coordinates) stored in the final difference coordinate set data Do (step 112). The value stored in the final difference coordinate set data Do is used as the initial difference coordinate set in this subroutine. The CPU 30 also updates the initial difference inclination data Dk with the difference (directional vector) stored in the final difference inclination data Dp (step 113). The directional vector stored in the final difference inclination data Dp is used as the initial difference inclination in this subroutine. In step 113, the difference stored in the final difference inclination data Dp is used as the final difference inclination in this subroutine. The CPU 30 updates the final difference coordinate set data Do with 0 (x,y,z=(0,0,0)) (step 114), and terminates the processing in this subroutine.

Returning to FIG. 18, after the second swing initial processing (step 85), the CPU 30 executes correction and drawing processing (step 86) and advances the processing to the next step. The correction and drawing processing in step 86 is substantially the same as that in step 82 described above with reference to FIG. 20, and will not be described in detail.

Next, the CPU 30 adds “1” to the count value of the loop counter Di (step 87), and determines whether or not the count value has reached a predetermined value (step 88). As the predetermined value, the number of times that the processing in step 86 is repeated from when the bat object BO is located on the reach determination plane M until the swing termination is used. When it is determined that the count value has reached the predetermined value, the CPU 30 terminates the swing processing. By contrast, when it is determined that the count value has not reached the predetermined value, the CPU 30 returns the processing to step 86 to repeat the processing.

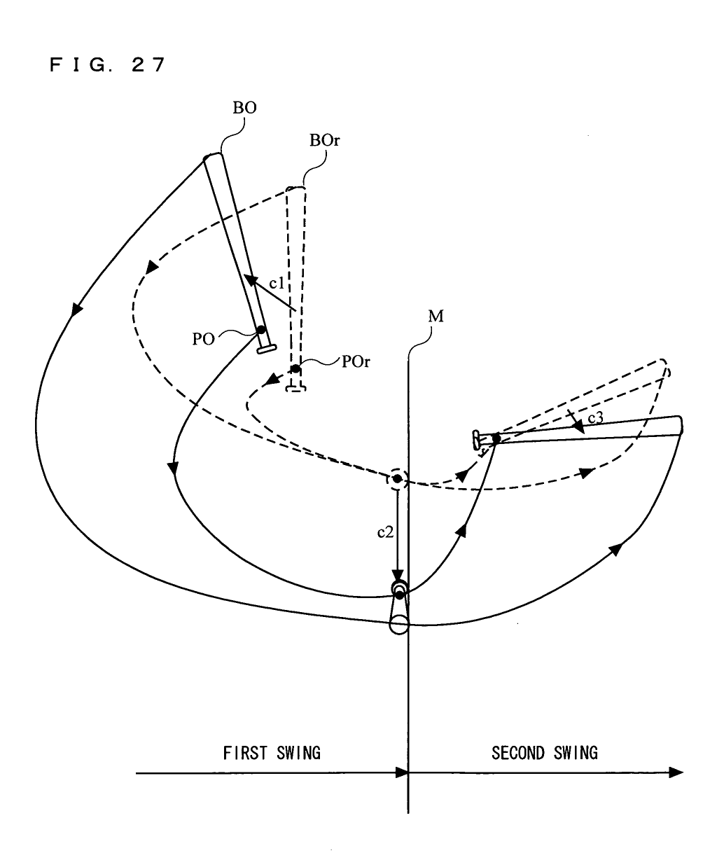

In order to give a specific description, an exemplary swing of the bat object BO displayed by the above-described swing processing will be described with reference to FIG. 27. In FIG. 27, bat object BOr swung by the reference motion data Dh is represented by the dashed line, and the actually drawn bat object BO is represented by the solid line.

In the above-described swing processing, correction and drawing processing is executed in two stages. The first stage is a first swing in which the swing start point of the bat object BO is the correction start point and a point in the middle of the swing is the correction termination point. The second stage is a second swing in which the point in the middle of the swing is the correction start point and the swing termination point is the correction termination point. At the swing start point, the differences in the support position and the inclination between the bat object BOr at the swing start point in the reference motion data Dh and the bat object BO corresponding the hold-up motion made by the player are calculated, and are respectively set as the initial difference coordinate set and the initial difference inclination in the first swing (arrow c1). At the point in the middle of the swing, the differences in the support position and the inclination between the bat object BOr matching the reach determination plane M in the reference motion data Dh and the bat object BO on the reach determination plane M corresponding to the ball reach point Cp are calculated, and are respectively set as the final difference coordinate set and the final difference inclination in the first swing (arrow c2). In the first swing, the differences from the display position and the inclination in the reference motion data Dh to the display position and the inclination of the bat object BO to be actually drawn are gradually changed as time passes from the initial difference coordinate set and the initial difference inclination to the final difference coordinate set and the final difference inclination. Thus, the swing motion of the bat object BO is obtained.

In the second swing, the final difference coordinate set and the final difference inclination in the first swing (arrow c2) are respectively used as the initial difference coordinate set and the initial difference inclination in the second swing. At the swing termination point, the difference between support position POr of the bat object BOr at the swing termination point in the reference motion data Dh and the support position PO of the bat object BO is set to 0 as the final difference coordinate set in the second swing. The final difference inclination in the first swing is used as the final difference inclination in the second swing (arrow c3). In the second swing also, the differences from the display position and the inclination in the reference motion data Dh to the display position and the inclination of the bat object BO to be actually drawn are gradually changed as time passes from the initial difference coordinate set and the initial difference inclination to the final difference coordinate set and the final difference inclination. Thus, the swing motion of the bat object BO is obtained.

As described above, the game apparatus main body 5 in this embodiment, when an input operation is made using the controller 7 including an acceleration sensor 701, draws the bat object BO using only the output from the acceleration sensor 701. In the drawing processing, the bat object BO is displayed while the differences in the display position and the inclination of the bat object BO to be actually drawn, with respect to the reference display position and the reference inclination (reference motion data Dh), are gradually changed as time passes from the differences at the start of the correction until the differences at the termination of the correction. The display positions and inclinations of the bat object BO displayed at the correction start point and the correction termination point have a certain degree of freedom in accordance with the operation state of the player. Using one piece of motion data, highly free correction can be performed. The start coordinate set from which the bat object BO starts moving and the coordinate set in the middle of the movement can be set freely. Therefore, the moving trajectory of the bat object BO can be corrected highly freely while being along the reference trajectory. In addition, the posture (inclination) of the bat object BO when the bat object BO starts moving and the posture in the middle of the movement can be set. Therefore, the correction can be performed in consideration of the inclination of the bat object BO in addition to the position thereof. As a result, the bat object BO can be corrected so as to appear to move more naturally than the case where the correction is performed using only the coordinate set of the position of the bat object BO. According to the present invention, the bat object BO can be corrected at a high degree of freedom so as to appear to move naturally and thus more realistically.

In the above embodiment, one point PO is provided in a lower part of the bat object BO to represent the position of the bat object BO. The swing motion of the bat object BO is defined by the support position PO and a directional vector representing the inclination of the bat object BO. The swing motion of the bat object BO may be set in a different manner. For example, a plurality of points which represent the position of the bat object BO may be provided in the bat object BO, and the position and the inclination angle thereof may be set by the plurality of points. Specifically, a point PA is provided in an upper part of the bat object BO in addition to the point PO in the lower part of the bat object BO. The inclination of the bat object BO is defined by the coordinate set of the point PA in the virtual game space. In this case, the difference inclination may be calculated by using the shift in the point PA. Thus, the present invention is applicable to the case of defining the position and inclination of the object by the coordinate sets of two points. In this case, the bat object BO is displayed while the differences between the plurality of display positions as reference and the plurality of display positions of the bat object BO to be actually drawn are gradually changed as time passes from the differences at the start of the correction until the differences at the termination of the correction. The data representing the object inclination, for example, a directional vector, is not corrected.

Alternatively, for an object which can be determined in terms of the position and the state in the virtual game space by one point representing the position of the object (e.g., an object of a point-symmetric shape or an object having a fixed inclination), the correction and drawing processing may be executed on this one point. In this case, the object is displayed while the difference between one display position as reference and the display position of the object to be actually drawn is gradually changed as time passes from the difference at the start of the correction until the difference at the termination of the correction.

Still alternatively, the correction and drawing processing may be executed using only the object inclination. In this case, the object is displayed while the difference between the inclination as reference and the inclination of the object to be actually drawn is gradually changed as time passes from the difference at the start of the correction until the difference at the termination of the correction. Data representing the position of the object, such as a coordinate set or the like, is not corrected.

The above-described correction and drawing processing is executed in two stages. The first stage is a first swing in which the swing start point of the bat object BO is the correction start point and a point in the middle of the swing is the correction termination point. The second stage is a second swing in which the point in the middle of the swing is the correction start point and the swing termination point is the correction termination point. The final difference coordinate set at the correction termination point in the second swing is set to 0 (specifically, 0,0,0). Alternatively, the initial difference coordinate set at the correction start point may be equal to the final difference coordinate set in the second swing (i.e., the difference coordinate set used in step 104 is always the same) In the above embodiment, the final difference inclination at the correction termination point in the second swing is equal to the initial difference inclination in the second swing. As a result, the difference inclination used in step 104 is always the same. Alternatively, the final difference inclination in the second swing may be 0 (specifically, the magnitude of the directional vector may be 0).

In the above game example, the baseball bat is processed using three-axial acceleration data which is output from the controller 7. The present invention is applicable to other types of games. For example, the present invention is applicable to a game in which the player character handles some type of object (specifically, an elongate object such as a sword, bamboo sword, or rod), or a game in which the object is moved in the virtual game space, needless to say. In the above embodiment, the game apparatus main body 5 for determining the movement or inclination of the controller 7 is included in the game system 1. The present invention is applicable to an information processing apparatus such as a general personal computer, which is operated by an input device including an acceleration sensor. Various types of processing can be executed based on determination results on an input device. For example, an object displayed by the information processing apparatus may be moved in accordance with the determined motion or inclination of the input device.

In the above embodiment, the acceleration sensor 701 included in the controller 7 is a three-axial acceleration sensor for detecting and outputting an acceleration as a component of each of three axial directions perpendicular to one another. The present invention can be realized with an acceleration sensor for detecting and outputting an acceleration in each of at least two axial directions perpendicular to each other. For example, an acceleration sensor for detecting and outputting an acceleration component of each of two axial directions (X- and Y-axis directions) (see FIG. 3 and FIG. 4) of the three-dimensional space accommodating the controller 7 is usable. With such an acceleration sensor, the movement of the support position along the x-axis and z-axis directions and the inclination along the x-axis and z-axis directions can be determined. In this case, where the acceleration in the X-axis direction and the acceleration in the Y-axis direction are both 0, the controller 7 can be determined as standing upright. A centrifugal component generated by a swing obtained from the acceleration components in the X- and Y-axis directions may be used to determine that the swing has been started, although the determination on the start of the swing using the acceleration component in the Z-axis direction cannot be made in this case. A different sensor from the acceleration sensor 701 may be used to determine that the swing has been started. Alternatively, a game rule that one of the operation buttons 72 should be pressed when the player swings the controller 7 may be provided, so that the start of the swing can be determined by such a button being pressed.

The present invention can still be realized with an acceleration sensor for detecting and outputting an acceleration in only one axial direction. For example, an acceleration sensor for detecting and outputting an acceleration component in the Y-axis direction (see FIG. 3 and FIG. 4) of the three-dimensional space accommodating the controller 7 is usable. With such an acceleration sensor, the movement of the support position along the x-axis direction and the inclination along the x-axis direction can be determined. In this case, where the detected acceleration in the Y-axis direction is 0, the controller 7 is assumed to be standing upright. The bat object BO is moved and inclined in the x-axis direction in the virtual game space. For drawing the bat object BO as moving and inclining in one direction, an acceleration sensor for detecting an acceleration in one axial direction is usable.

As described above, the present invention can be realized by using a gyrosensor as a sensor for detecting the motion of the controller 7. When a gyrosensor is used, the inclination value is initialized before the detection is started. For example, the player presses an operation section 72 while keeping the controller 7 at a predetermined posture or keeps the controller 7 at the posture displayed on the monitor 2. Thus, the output of the gyrosensor in that state is initialized. After the detection is started, the angular rate data which is output from the gyrosensor is integrated, and a change amount in the inclination is calculated from the initialized inclination value. In this case, the calculated inclination corresponds to the angle.

For example, in the scaling in step 61, the change amount in the inclination around the X-axis direction, which is obtained from the gyrosensor, is used. The change amount is scaled to the movable range of the x-axis direction (−3 to +3) to calculate the x-axis direction movable width wx. In the scaling in step 62, the change amount in the inclination around the Z-axis direction, which is obtained from the gyrosensor, is used. The change amount is scaled to the movable range of the z-axis direction (−3 to +3) to calculate the z-axis direction movable width wz. In step 71, the change amount in the inclination around each of the X-, Y-and Z-axis directions, which is obtained from the gyrosensor, is used to calculate the current inclination of the controller 7. Instep 55, the determination on whether or not the player performed an operation to start a motion of swinging the bat can be made by determining whether or not the magnitude of the angular rate represented by the angular rate data around the Y-axis direction, which is output from the gyrosensor, is equal to or greater than a predetermined value.

In the above description, the controller 7 and the game apparatus main body 5 communicate each other wirelessly. Alternatively, the controller 7 and the game apparatus main body 5 may be electrically connected to each other via a cable. In this case, the cable connected to the controller 7 is connected to a connection terminal of the game apparatus main body 5.

The shape of the controller 7, and the shape, number, position or the like of the operation sections 72 provided in the controller 7 are merely exemplary, and may be altered without departing from the scope of the present invention. The position of the imaging information calculation section 74 in the controller 7 (the light incident opening of the imaging information calculation section 74) does not need to be on the front surface of the housing 71, and may be on another surface as long as light can enter from the outside of the housing 71.

A game program according to the present invention may be provided to the game apparatus main body 5 via an external storage medium such as the optical disc 4 or the like, via a wired communication line, or wirelessly. The game program may be stored on a nonvolatile storage medium in the game apparatus main body 5 in advance. The information storage medium for storing the game program maybe a CD-ROM, a DVD, a similar optical disc-shaped storage medium or a nonvolatile semiconductor memory.

A storage medium having a game program stored thereon and a game apparatus according to the present invention, when an input operation is made using an input device including an acceleration sensor, allow an object drawn using the input device to be corrected at a high degree of freedom so as to appear to move naturally, and are useful for a device or a program for drawing an object in accordance with a motion of a game controller or the like.

While the invention has been described in detail, the foregoing description is in all aspects illustrative and not restrictive. It is understood that numerous other modifications and variations can be devised without departing from the scope of the invention.

What is claimed is:

1. A storage medium having stored thereon a game program executable by a computer of a game apparatus for obtaining motion data from an input device including a motion sensor for outputting the motion data in accordance with a motion of the input device, moving an object located in a virtual game space and displaying the object on a display device, wherein a reference trajectory along which the object moves in the virtual game space is stored on a memory, the game program causing the computer to execute:
a motion data obtaining step of obtaining the motion data which is output from the motion sensor;
a start coordinate set calculation step of calculating a moving start coordinate set associated with the object in the virtual game space, based on the motion data obtained in the motion data obtaining step;
a first difference calculation step of calculating a first corresponding point on the reference trajectory corresponding to the moving start coordinate set from the reference trajectory stored on the memory, and calculating a first difference coordinate set, which is a difference between the first corresponding point and the moving start coordinate set;
a target coordinate set calculation step of calculating a target coordinate set associated with the object in the virtual game space;
a second difference calculation step of calculating a second corresponding point on the reference trajectory corresponding to the target coordinate set from the reference trajectory stored on the memory, and calculating a second difference coordinate set, which is a difference between the second corresponding point and the target coordinate set;
a change difference coordinate set calculation step of calculating a change difference coordinate set which changes from the first difference coordinate set to the second difference coordinate set in accordance with a time passage after a predetermined condition is fulfilled;
a correction coordinate set calculation step of adding the change difference coordinate set calculated in accordance with the time passage to a coordinate set on the reference trajectory in accordance with the time passage to calculate a correction coordinate set; and
a display control step of locating the object at a position corresponding to the correction coordinate set in the virtual game space and displaying the object on the display device.

2. A storage medium according to claim 1, wherein:
in the start coordinate set calculation step, the moving start coordinate set is calculated when the predetermined condition is fulfilled;
in the first difference calculation step, the first difference coordinate set is calculated when the predetermined condition is fulfilled;
in the target coordinate set calculation step, the target coordinate set is calculated when the predetermined condition is fulfilled; and
in the second difference calculation step, the second difference coordinate set is calculated when the predetermined condition is fulfilled.

3. A storage medium according to claim 1, wherein in the change difference coordinate set calculation step, the change difference coordinate set is calculated so as to be changed from the first difference coordinate set to the second difference coordinate set by a constant ratio in accordance with the time passage.

4. A storage medium according to claim 1, wherein:
the game program causes the computer to further execute a determination step of determining that the predetermined condition is fulfilled when a value represented by the motion data obtained in the motion data obtaining step is equal to or greater than a predetermined value; and
in the change difference coordinate set calculation step, the change difference coordinate set is calculated in accordance with the time passage after it is determined that the predetermined condition is fulfilled in the determination step.

5. A storage medium according to claim 1, wherein in the target coordinate set calculation step, the target coordinate set in the virtual game space is calculated based on a game parameter which changes in accordance with predetermined game processing.

6. A storage medium according to claim 1, wherein:
in the target coordinate set calculation step, the target coordinate set is calculated on a predetermined plane which is set in the virtual game space; and
in the second difference calculation step, an intersection of the predetermined plane and the reference trajectory is set as the second corresponding point on the reference trajectory corresponding to the target coordinate set.

7. A storage medium according to claim 1, wherein:
the game program causes the computer to further execute an another object moving step of moving another object in the virtual game space; and
in the target coordinate set calculation step, a prospected intersection position, at which the predetermined plane set in the virtual game space and the another object cross each other, is prospected based on a prospected movement of the another object, and the target coordinate set associated with the object contacting the another object at the prospected intersection position in the virtual game space is calculated.

8. A storage medium according to claim 1, wherein:
the motion sensor is an acceleration sensor for detecting an acceleration in at least one axial direction applied to the input device; and
the motion data is acceleration data representing the acceleration detected by the acceleration sensor.

9. A storage medium having stored there on a game program executable by a computer of a game apparatus for obtaining motion data from an input device including a motion sensor for outputting the motion data in accordance with a motion of the input device, moving an object located in a virtual game space and displaying the object on a display device, wherein a reference inclination transition which represents reference for an inclination change of the object in accordance with the movement thereof in the virtual game space is stored on a memory, the game program causing the computer to execute:
a motion data obtaining step of obtaining the motion data which is output from the motion sensor;
a start inclination calculation step of calculating an inclination of the object when the object starts moving in the virtual game space, based on the motion data obtained in the motion data obtaining step;
a first difference calculation step of calculating a reference inclination corresponding to the inclination calculated in the start inclination calculation step from the reference inclination transition stored on the memory, and calculating a first difference inclination, which is a difference between the reference inclination and the inclination calculated in the start inclination calculation step;
a target inclination calculation step of calculating a target inclination of the object in the virtual game space;
a second difference calculation step of calculating a reference inclination corresponding to the target inclination from the reference inclination transition stored on the memory, and calculating a second difference inclination, which is a difference between the reference inclination and the target inclination;
a change difference inclination calculation step of calculating a change difference inclination which changes from the first difference inclination to the second difference inclination in accordance with a time passage after a predetermined condition is fulfilled;
a correction inclination calculation step of adding the change difference inclination calculated in accordance with the time passage to the reference inclination transition in accordance with the time passage to calculate a correction inclination; and
a display control step of setting the inclination of the object in the virtual game space as the correction inclination and displaying the object on the display device.

10. A storage medium according to claim 9, wherein:
in the start inclination calculation step, the inclination of the object when the object starts moving is calculated when the predetermined condition is fulfilled;
in the first difference calculation step, the first difference inclination is calculated when the predetermined condition is fulfilled;
in the target inclination calculation step, the target inclination is calculated when the predetermined condition is fulfilled; and
in the second difference calculation step, the second difference inclination is calculated when the predetermined condition is fulfilled.

11. A storage medium according to claim 9, wherein in the change difference inclination calculation step, the change difference inclination is calculated so as to be changed from the first difference inclination to the second difference inclination by a constant ratio in accordance with the time passage.

12. A storage medium according to claim 9, wherein:
the game program causes the computer to further execute a determination step of determining that the predetermined condition is fulfilled when a value represented by the motion data obtained in the motion data obtaining step is equal to or greater than a predetermined value; and
in the change difference inclination calculation step, the change difference inclination is calculated in accordance with the time passage after it is determined that the predetermined condition is fulfilled in the determination step.

13. A storage medium according to claim 9, wherein in the target inclination calculation step, the target inclination in the virtual game space is calculated based on a game parameter which changes in accordance with predetermined game processing.

14. A storage medium according to claim 9, wherein:
in the target inclination calculation step, the target inclination is calculated for the object located on a predetermined plane which is set in the virtual game space; and
in the second difference calculation step, the inclination of the object located on the predetermined plane in the reference inclination transition is set as the reference inclination corresponding to the target inclination.

15. A storage medium according to claim 9, wherein:
the game program causes the computer to further execute an another object moving step of moving another object in the virtual game space; and
in the target inclination calculation step, a prospected intersection position, at which the predetermined plane set in the virtual game space and the another object cross each other, is prospected based on a prospected movement of the another object, and the inclination of the object located at the prospected intersection position is calculated as the target inclination.

16. A storage medium according to claim 9, wherein:
the motion sensor is an acceleration sensor for detecting an acceleration in at least one axial direction applied to the input device; and
the motion data is acceleration data representing the acceleration detected by the acceleration sensor.

17. A game apparatus for obtaining motion data from an input device including a motion sensor for outputting the motion data in accordance with a motion of the input device, moving an object located in a virtual game space and displaying the object on a display device, the game apparatus comprising:
a memory for storing a reference trajectory along which the object moves in the virtual game space;
motion data obtaining means for obtaining the motion data which is output from the motion sensor;
start coordinate set calculation means for calculating a moving start coordinate set associated with the object in the virtual game space, based on the motion data obtained by the motion data obtaining means;
first difference calculation means for calculating a first corresponding point on the reference trajectory corresponding to the moving start coordinate set from the reference trajectory stored on the memory, and calculating a first difference coordinate set, which is a difference between the first corresponding point and the moving start coordinate set;
target coordinate set calculation means for calculating a target coordinate set associated with the object in the virtual game space;
second difference calculation means for calculating a second corresponding point on the reference trajectory corresponding to the target coordinate set from the reference trajectory stored on the memory, and calculating a second difference coordinate set, which is a difference between the second corresponding point and the target coordinate set;
change difference coordinate set calculation means for calculating a change difference coordinate set which changes from the first difference coordinate set to the second difference coordinate set in accordance with a time passage after a predetermined condition is fulfilled;
correction coordinate set calculation means for adding the change difference coordinate set calculated in accordance with the time passage to a coordinate set on the reference trajectory in accordance with the time passage to calculate a correction coordinate set; and
display control means for locating the object at a position corresponding to the correction coordinate set in the virtual game space and displaying the object on the display device.

18. A game apparatus for obtaining motion data from an input device including a motion sensor for outputting the motion data in accordance with a motion of the input device, moving an object located in a virtual game space and displaying the object on a display device, the game apparatus comprising:
a memory for storing a reference inclination transition which represents reference for an inclination change of the object in accordance with the movement thereof in the virtual game space;
motion data obtaining means for obtaining the motion data which is output from the motion sensor;
start inclination calculation means for calculating an inclination of the object when the object starts moving in the virtual game space, based on the motion data obtained by the motion data obtaining means;
first difference calculation means for calculating a reference inclination corresponding to the inclination calculated by the start inclination calculation means from the reference inclination transition stored on the memory, and calculating a first difference inclination, which is a difference between the reference inclination and the inclination calculated by the start inclination calculation means;
target inclination calculation means for calculating a target inclination of the object in the virtual game space;
second difference calculation means for calculating a reference inclination corresponding to the target inclination from the reference inclination transition stored on the memory, and calculating a second difference inclination, which is a difference between the reference inclination and the target inclination;
change difference inclination calculation means for calculating a change difference inclination which changes from the first difference inclination to the second difference inclination in accordance with a time passage after a predetermined condition is fulfilled;
correction inclination calculation step of adding the change difference inclination calculated in accordance with the time passage to the reference inclination transition in accordance with the time passage to calculate a correction inclination; and
display control means for setting the inclination of the object in the virtual game space as the correction inclination and displaying the object on the display device.
